(19) United States
(12) Patent Application Publication
(10) Pub. No.: US 2023/0033281 A1
(43) Pub. Date: Feb. 2, 2023

(54) STABILIZER COMPOSITIONS AND STABILIZED HEAT TRANSFER COMPOSITIONS, METHODS AND SYSTEMS

(71) Applicant: HONEYWELL INTERNATIONAL INC., Charlotte, NC (US)

(72) Inventors: Bin YU, Charlotte, NC (US); Alexey KRUGLOV, Charlotte, NC (US)

(73) Assignee: HONEYWELL INTERNATIONAL INC., Charlotte, NC (US)

(21) Appl. No.: 17/847,102

(22) Filed: Jun. 22, 2022

Related U.S. Application Data
(60) Provisional application No. 63/213,959, filed on Jun. 23, 2021.

(51) Int. Cl. C10M 129/18; C09K 5/04; C10M 107/24; C10M 169/04

(52) U.S. Cl. CPC C10M 129/18; C09K 5/044; C10M 107/24; C10M 169/04; C09K 2205/12; C10M 2209/043; C10M 2207/042; C10N 2040/30

(57) ABSTRACT

The present invention relates to heat transfer compositions comprising refrigerant, lubricant and stabilizer, wherein the refrigerant comprises from about 10% by weight to 100% by weight of trifluoroiodomethane (CF₃I), and wherein said lubricant comprises polyol ester (POE) lubricant and/or polyvinyl ether (PVE) lubricant, and wherein said stabilizer comprises at least one stabilizing compound according to the following Formula I:

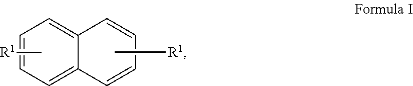

where each R¹ is independently an epoxy terminated ethoxy, propoxy or butoxy group.

### CROSS REFERENCE TO RELATED APPLICATIONS

This application is related to and claims the priority benefit of U.S. Provisional Application 63/213,959, filed Jun. 23, 2021, which is incorporated herein by reference.

### FIELD OF THE INVENTION

The present invention relates to stabilizer compositions and to compositions, methods and systems having utility in heat exchange applications, including in air conditioning and refrigeration applications. In particular but not limiting aspects, the invention relates to compositions useful in heat transfer systems of the type in which the refrigerant R-410A would have been used. The refrigerant and heat transfer compositions of the invention are useful in particular as a replacement of the refrigerant R-410A for heating and cooling applications and to retrofitting heat exchange systems, including systems designed for use with R-410A.

### BACKGROUND

Mechanical refrigeration systems, and related heat transfer devices, such as heat pumps and air conditioners are well known in the art for industrial, commercial and domestic uses. Chlorofluorocarbons (CFCs) were developed in the 1930s as refrigerants for such systems. However, since the 1980s, the effect of CFCs on the stratospheric ozone layer has become the focus of much attention. In 1987, a number of governments signed the Montreal Protocol to protect the global environment, setting forth a timetable for phasing out the CFC products. CFCs were replaced with more environmentally acceptable materials that contain hydrogen, namely the hydrochlorofluorocarbons (HCFCs).

One of the most commonly used hydrochlorofluorocarbon refrigerants was chlorodifluoromethane (HCFC-22). However, subsequent amendments to the Montreal protocol accelerated the phase out of the CFCs and scheduled the phase-out of HCFCs, including HCFC-22.

In response to the need for a non-flammable, non-toxic alternative to the CFCs and HCFCs, industry has developed a number of hydrofluorocarbons (HFCs) which have zero ozone depletion potential. R-410A (a 50:50 w/w blend of difluoromethane (HFC-32) and pentafluoroethane (HFC-125)) was adopted as the industry replacement for HCFC-22 in air conditioning and chiller applications as it does not contribute to ozone depletion. However, R-410A is not a drop-in replacement for R-22. Thus, the replacement of R-22 with R-410A required the redesign of major components within heat exchange systems, including the replacement and redesign of the compressor to accommodate the substantially higher operating pressure and volumetric capacity of R-410A, when compared with R-22.

While R-410A has a more acceptable Ozone Depleting Potential (ODP) than R-22, the continued use of R-410A is problematic since it has a high Global Warming Potential of 2088. There is therefore a need in the art for the replacement of R-410A with a more environmentally acceptable alternative.

The EU implemented the F-gas regulation to limit HFCs which can be placed on the market in the EU from 2015 onwards, as shown in Table 1. By 2030, only 21% of the quantity of HFCs that were sold in 2015 will be available. Therefore, it is desired to limit GWP below 427 as a long-term solution.

TABLE 1
F-Gas Regulation

| Year | Phasedown Percentage | GWP Level |
|---|---|---|
| 2015 | 100% | 2034* |
| 2016-2017 | 93% | 1891 |
| 2018-2020 | 63% | 1281 |
| 2021-2023 | 67% | 915 |
| 2024-2026 | 31% | 630 |
| 2027-2029 | 24% | 488 |
| After 2030 | 21% | 427 |

*2015 GWP level is based on UNEP 2012 Use Study with no growth rate.

It is understood in the art that it is highly desirable for a replacement heat transfer fluid to possess a difficult to achieve mosaic of properties including excellent heat transfer properties (and in particular heat transfer properties that are well matched to the needs of the particular application), chemical stability, low or no toxicity, non-flammability, lubricant miscibility and/or lubricant compatibility amongst others. In addition, any replacement for R-410A would ideally be a good match for the operating conditions of R-410A in order to avoid modification or redesign of the system. The development of a heat transfer fluid meeting all of these requirements, many of which are unpredictable, is a significant challenge.

With regard to efficiency in use, it is important to note that a loss of refrigerant thermodynamic performance or energy efficiency may result in an increase in fossil fuel usage as a result of the increased demand for electrical energy. The use of such a refrigerant will therefore have a negative secondary environmental impact.

Flammability is considered to be an important property for many heat transfer applications. As used herein, the term “non-flammable” refers to compounds or compositions which are determined to be non-flammable in accordance with ASTM standard E-681-2009 Standard Test Method for Concentration Limits of Flammability of Chemicals (Vapors and Gases) at conditions described in ASHRAE Standard 34-2016 Designation and Safety Classification of Refrigerants and described in Appendix B1 to ASHRAE Standard 34-2016, which is incorporated herein by reference and referred to herein for convenience as “Non-Flammability Test”.

It is very important for maintenance of system efficiency and proper and reliable functioning of the compressor, that lubricant circulating in a vapor compression heat transfer system is returned to the compressor to perform its intended lubricating function. Otherwise, lubricant might accumulate and become lodged in the coils and piping of the system, including in the heat transfer components. Furthermore, when lubricant accumulates on the inner surfaces of the evaporator, it lowers the heat exchange efficiency of the evaporator, and thereby reduces the efficiency of the system.

R-410A is currently commonly used with polyol ester (POE) lubricating oil in air conditioning applications, as R-410A is miscible with POE at temperatures experienced during use of such systems. However, R-410A is immiscible with POE at temperatures typically experienced during operation of low temperature refrigeration systems, and heat pump systems. Therefore, unless steps are taken to mitigate against this immiscibility, POE and R-410A cannot be used in low temperature refrigeration or heat pump systems.

Highly advantageous heat transfer compositions which address many of needs described above have been developed by the assignee of the present invention. These heat transfer compositions comprise a refrigerant that includes as an important component trifluoroiodomethane (CF3I). See for example US 2020-0131416, US 2020-0131417, US 2020-0131418, and US 2021-0095177, each of which has been incorporated herein by reference in its entirety as if fully set forth below. While these publications recognize and provide a potential solution to the possibility of a stability concern with CF3I containing refrigerants, the present inventors have come to appreciate that more desirable and unexpectedly improved levels of stability can be achieved by use of new stabilizer components for use in connection with such refrigerants, especially when used with PVE and POE lubricants.

A variety of stabilizers for use with HCFC and CFC compositions are known. HFCs, due to their exceptional stability, may or may not use stabilizers incorporated in their compositions as known in the art. For example, U.S. Pat. No. 5,380,449 discloses compositions comprising dichlorotrifluoroethane and stabilizing amounts of at least one phenol and at least one aromatic or fluorinated alkyl epoxide. However, because iodo-compounds tend to be significantly less stable that CFCs and HCFCs, it cannot be predicted from teachings of stabilizers for CFCs and HCFCs (e.g., the '449 disclosure) whether the same or similar compounds are capable of stabilizing iodo-compounds to a sufficient degree for use as CFC/HCFC replacements. That is, as will be recognized by those of skill in the art, C—Cl and C—F bonds tend to be at least about 1.5-2 times stronger than C—I bonds. Accordingly, it is neither inherent nor necessarily reasonable to expect that a compound that stabilizes an HCFC or CFC will be suitable for an iodo-compound which requires about twice the amount of added stability to be useful in refrigerant applications.

### SUMMARY

The present invention includes a variety of compositions comprising iodocarbon compounds, such as trifluoroiodomethane (CF₃I), that are surprisingly stable and can be used advantageously in a variety of applications, including as refrigerants in various cooling systems.

The present invention is therefore directed, in one aspect, to heat transfer compositions comprising at least one iodocarbon compound, preferably a C1-C5 iodocarbon, even more preferably a C1 iodocarbon such as CF3I, and at least one stabilizing compound according to the following Formula I:

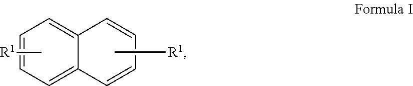

where each R1 is independently an epoxy terminated ethoxy, propoxy or butoxy group. The heat transfer composition according to this paragraph is sometimes referred to herein for convenience as Heat Transfer Composition 1.

The present invention also includes heat transfer compositions comprising at least one iodocarbon compound, preferably a C1-C5 iodocarbon, even more preferably a C1 iodocarbon such as CF3I, and at least one stabilizing compound according to the following Formula I:

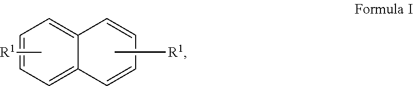

where each R¹ is independently an epoxy terminated ethoxy or propoxy group. The heat transfer composition according to this paragraph is sometimes referred to herein for convenience as Heat Transfer Composition 2.

The present invention also includes heat transfer compositions comprising at least one iodocarbon compound, preferably a C1-C5 iodocarbon, even more preferably a C1 iodocarbon such as CF3I, and at least one stabilizing compound according to the following Formula I:

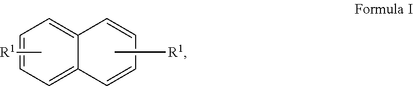

where each R¹ is independently an epoxy terminated ethoxy, propoxy or butoxy group, provided that at least one R¹ is an epoxy terminated ethoxy group. The heat transfer composition according to this paragraph is sometimes referred to herein for convenience as Heat Transfer Composition 3.

The present invention also includes heat transfer compositions comprising at least one iodocarbon compound, preferably a C1-C5 iodocarbon, even more preferably a C1 iodocarbon such as CF3I, and at least one stabilizing compound according to the following Formula I:

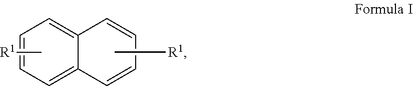

where each R¹ is independently an epoxy terminated ethoxy or propoxy group, provided that at least one R¹ is an epoxy terminated ethoxy group. The heat transfer composition according to this paragraph is sometimes referred to herein for convenience as Heat Transfer Composition 4.

The present invention also includes heat transfer compositions comprising at least one iodocarbon compound, preferably a C1-C5 iodocarbon, even more preferably a C1 iodocarbon such as CF3I, and at least one stabilizing compound according to the following Formula I:

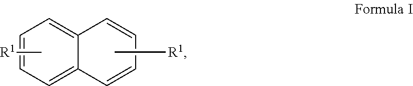

where each R¹ is an epoxy terminated ethoxy group. The heat transfer composition according to this paragraph is sometimes referred to herein for convenience as Heat Transfer Composition 5.

The present invention also includes heat transfer compositions comprising at least one iodocarbon compound, preferably a C1-C5 iodocarbon, even more preferably a C1 iodocarbon such as CF3I, and at least the following stabilizing compound according to Formula I in which each R¹ is an epoxy terminated ethoxy group, as depicted below:

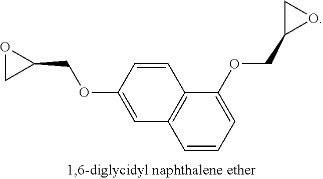 [SMILES: c1cc(OC[C@H]2CO2)c2ccc(OC[C@H]3CO3)cc2c1]

The heat transfer composition according to this paragraph is sometimes referred to herein for convenience as Heat Transfer Composition 6.

The present invention includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising at least one stabilizing compound according to the following Formula I:

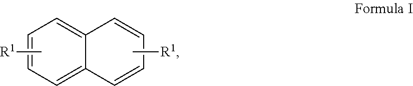

where each R¹ is independently an epoxy terminated ethoxy, propoxy group or butoxy group. The heat transfer composition according to this paragraph is sometimes referred to herein for convenience as Heat Transfer Composition 7.

The present invention also includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising at least one stabilizing compound according to the following Formula I:

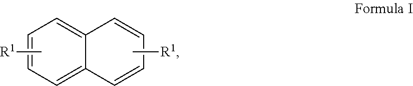

where each R¹ is independently an epoxy terminated ethoxy or propoxy group. The heat transfer composition according to this paragraph is sometimes referred to herein for convenience as Heat Transfer Composition 8.

The present invention also includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising at least one stabilizing compound according to the following Formula I:

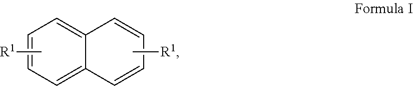

where each R¹ is independently an epoxy terminated ethoxy, propoxy or butoxy group, provided that at least one R¹ is an epoxy terminated ethoxy group. The heat transfer composition according to this paragraph is sometimes referred to herein for convenience as Heat Transfer Composition 9.

The present invention also includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising at least one stabilizing compound according to the following Formula I:

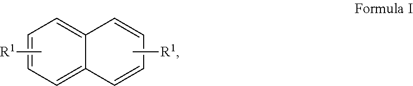

where each R¹ is independently an epoxy terminated ethoxy or propoxy group, provided that at least one R¹ is an epoxy terminated ethoxy group. The heat transfer composition according to this paragraph is sometimes referred to herein for convenience as Heat Transfer Composition 10.

The present invention also includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising at least one stabilizing compound according to the following Formula I:

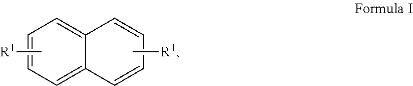

where each R¹ is an epoxy terminated ethoxy group. The heat transfer composition according to this paragraph is sometimes referred to herein for convenience as Heat Transfer Composition 11.

The present invention also includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising at least the following stabilizing compound according to Formula I in which each R¹ is an epoxy terminated ethoxy group, as depicted below:

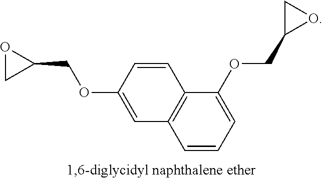 [SMILES: c1cc(OC[C@H]2CO2)c2ccc(OC[C@H]3CO3)cc2c1]

The heat transfer composition according to this paragraph is sometimes referred to herein for convenience as Heat Transfer Composition 12.

The present invention includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising at least one stabilizing compound according to the following Formula I:

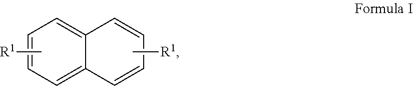

where each R¹ is independently an epoxy terminated ethoxy, propoxy or butoxy group alkylated naphthalene, wherein said stabilizer is present in the composition in an amount of from 1% to less than 10% by weight based on the weight of the stabilizer and the lubricant. The heat transfer composition according to this paragraph is sometimes referred to herein for convenience as Heat Transfer Composition 13.

The present invention includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising (i) at least one alkylated naphthalene and (ii) at least one stabilizing compound according to the following Formula I:

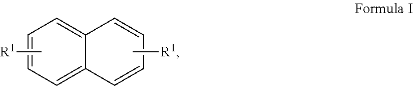

where each R¹ is independently an epoxy terminated ethoxy, propoxy or butoxy group, wherein said stabilizer is present in the composition in an amount of from 1% to less than 10% by weight based on the weight of the stabilizer and the lubricant. The heat transfer composition according to this paragraph is sometimes referred to herein for convenience as Heat Transfer Composition 14.

The present invention includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising (i) at least one alkylated naphthalene and (ii) at least one stabilizing compound according to the following Formula I:

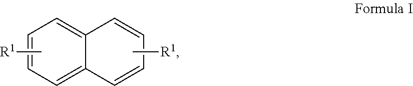

where each R¹ is independently an epoxy terminated ethoxy or propoxy group, wherein said stabilizer is present in the composition in an amount of from 1% to less than 10% by weight based on the weight of the stabilizer and the lubricant. The heat transfer composition according to this paragraph is sometimes referred to herein for convenience as Heat Transfer Composition 14A.

The present invention includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising (i) at least one alkylated naphthalene and (ii) at least one stabilizing compound according to the following Formula I:

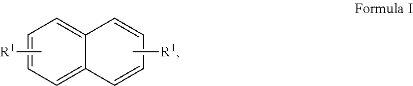

where each R¹ is an epoxy terminated ethoxy group, wherein said stabilizer is present in the composition in an amount of from 1% to less than 10% by weight based on the weight of the stabilizer and the lubricant. The heat transfer composition according to this paragraph is sometimes referred to herein for convenience as Heat Transfer Composition 15.

The present invention includes heat transfer compositions comprising refrigerant, lubricant and stabilizer, said refrigerant comprising from about 5% by weight to 100% by weight of trifluoroiodomethane (CF3I), said lubricant comprising polyol ester (POE) lubricant and/or polyvinyl ether (PVE) lubricant, and said stabilizer comprising (i) at least one alkylated naphthalene and (ii) at least the following stabilizing compound according to Formula I hereof in which each R¹ is an epoxy terminated ethoxy group:

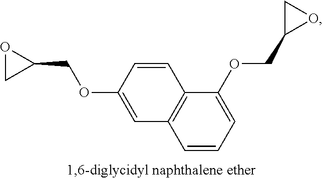 [SMILES: c1cc(OC[C@H]2CO2)c2ccc(OC[C@H]3CO3)cc2c1]

and wherein said stabilizer is present in the composition in an amount of from 1% to less than 10% by weight based on the weight of the stabilizer and the lubricant. The heat transfer composition according to this paragraph is sometimes referred to herein for convenience as Heat Transfer Composition 16.

The present invention also includes any of Heat Transfer Compositions 1-16 wherein said stabilizer further comprises BHT. The heat transfer composition according to this paragraph is sometimes referred to herein for convenience as Heat Transfer Composition 16A.

The present invention also includes any of Heat Transfer Compositions 1-16 wherein said stabilizer further comprises an acid depleting moiety (ADM). The heat transfer composition according to this paragraph is sometimes referred to herein for convenience as Heat Transfer Composition 16B.

As used herein, the term “acid depleting moiety” (which is sometimes referred to herein for convenience as “ADM”) means a compound or radical which when present in a heat transfer composition comprising a refrigerant that contains about 10% by weigh or greater of CF3I (said percentage being based in the weight of all the refrigerants in the heat transfer composition), has the effect of substantially reducing the acid moieties that would otherwise be present in the heat transfer composition. As used herein, the term “substantially reducing” as used with respect to the acid moieties in the heat transfer composition means that acid moieties are reduced sufficiently to result in a reduction in TAN value (as defined hereinafter) of at least about 10 relative percent.

The present invention also includes a stabilizer composition comprising at least one stabilizing compound according to the following Formula I:

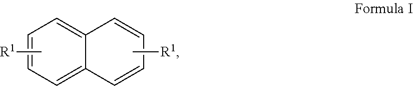

where each R¹ is independently an epoxy terminated ethoxy, propoxy group or butoxy group and at least one co-stabilizer. The stabilizer composition according to this paragraph is sometimes referred to herein for convenience as Stabilizer 1.

The present invention also includes a stabilizer composition comprising from about 40% by weight to about 99.9% by weight of at least one stabilizing compound according to the following Formula I:

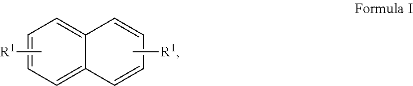

where each R¹ is independently an epoxy terminated ethoxy, propoxy or butoxy group, and from 0.1% to about 50% by weight of at least one co-stabilizer. The stabilizer composition according to this paragraph is sometimes referred to herein for convenience as Stabilizer 2.

The present invention also includes a stabilizer composition comprising at least one stabilizing compound according to the following Formula I:

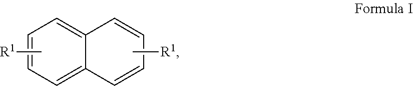

where each R1 is independently an epoxy terminated ethoxy or propoxy group and at least one co-stabilizer. The stabilizer composition according to this paragraph is sometimes referred to herein for convenience as Stabilizer 3.

The present invention also includes a stabilizer composition comprising from about 40% by weight to about 99.9% by weight of at least one stabilizing compound according to the following Formula I:

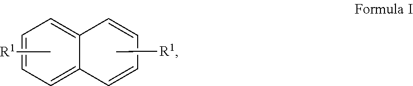

where each R1 is independently an epoxy terminated ethoxy or propoxy group, and from 0.1% to about 50% by weight of at least one co-stabilizer. The stabilizer composition according to this paragraph is sometimes referred to herein for convenience as Stabilizer 4.

The present invention also includes a stabilizer composition comprising at least one stabilizing compound according to the following Formula I:

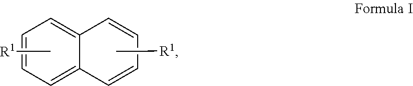

where each R1 is independently an epoxy terminated ethoxy group and at least one co-stabilizer. The stabilizer composition according to this paragraph is sometimes referred to herein for convenience as Stabilizer 5.

The present invention also includes a stabilizer composition comprising from about 40% by weight to about 99.9% by weight of at least one stabilizing compound according to the following Formula I:

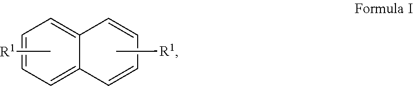

where each R1 is independently an epoxy terminated ethoxy, and from 0.1% to about 50% by weight of at least one co-stabilizer. The stabilizer composition according to this paragraph is sometimes referred to herein for convenience as Stabilizer 6.

The present invention also includes a stabilizer composition comprising at least the following stabilizing compound:

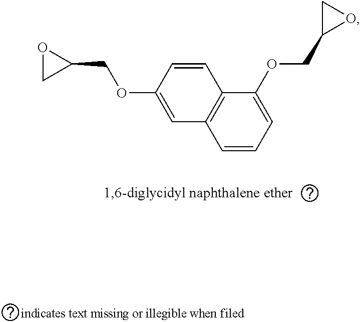 [SMILES: c1cc(OC[C@H]2CO2)c2ccc(OC[C@H]3CO3)cc2c1]

and at least one co-stabilizer. The stabilizer composition according to this paragraph is sometimes referred to herein for convenience as Stabilizer 7.

The present invention also includes a stabilizer composition comprising from about 40% by weight to about 99.9% by weight of at least the following stabilizing compound:

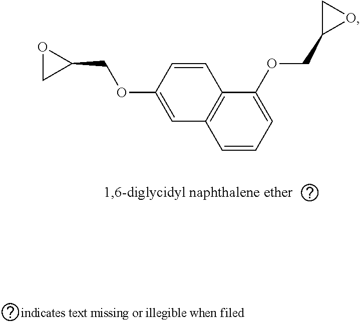 [SMILES: c1cc(OC[C@H]2CO2)c2ccc(OC[C@H]3CO3)cc2c1]

and from 0.1% to about 50% by weight of at least one co-stabilizer. The stabilizer composition according to this paragraph is sometimes referred to herein for convenience as Stabilizer 8.

The present invention also includes heat transfer compositions comprising refrigerant, lubricant comprising POE lubricant and/or polyvinyl ether (PVE) lubricant and a stabilizer according to any of Stabilizer 1 through Stabilizer 8, said refrigerant comprising from about 5% by weight to 100% by weight of trifluoroiodomethane (CF₃I). The heat transfer composition according to this paragraph is sometimes referred to herein for convenience as Heat Transfer Composition 17.

The present invention also includes heat transfer compositions comprising refrigerant, lubricant comprising POE lubricant and/or polyvinyl ether (PVE) lubricant and a stabilizer according to any of Stabilizer 1 through Stabilizer 8, said refrigerant comprising from about 20% by weight to about 75% by weight of trifluoroiodomethane (CF₃I). The heat transfer composition according to this paragraph is sometimes referred to herein for convenience as Heat Transfer Composition 18.

The present invention also includes heat transfer compositions comprising refrigerant, lubricant comprising POE lubricant and/or polyvinyl ether (PVE) lubricant and a stabilizer according to any of Stabilizer 1 through Stabilizer 8, said refrigerant comprising from about 5% by weight to about 50% by weight difluoromethane (HFC-32) and from about 35% by weight to about 70% by weight of trifluoroiodomethane (CF₃I). The heat transfer composition according to this paragraph is sometimes referred to herein for convenience as Heat Transfer Composition 19.

The present invention also includes heat transfer compositions comprising refrigerant, lubricant comprising POE lubricant and/or polyvinyl ether (PVE) lubricant and a stabilizer according to any of Stabilizer 1 through Stabilizer 8, said refrigerant comprising from about 30% by weight to about 50% by weight by weight difluoromethane (HFC-32), from 3 to 15% by weight pentafluoroethane (HFC-125) and from about 35% by weight to about 70% by weight of trifluoroiodomethane (CF₃I). The heat transfer composition according to this paragraph is sometimes referred to herein for convenience as Heat Transfer Composition 20.

The present invention also includes stabilized lubricants comprising: (a) POE lubricant and/or polyvinyl ether (PVE) lubricant; and (b and a stabilizer according to any of Stabilizer 1 through Stabilizer 8. The lubricant according to this paragraph is sometimes referred to herein for convenience as Lubricant 1.

The present invention also includes stabilized lubricants comprising: (a) POE lubricant; and (b) and a stabilizer according to any of Stabilizer 1 through Stabilizer 8. The lubricant according to this paragraph is sometimes referred to herein for convenience as Lubricant 2.

The present invention also includes stabilized lubricants comprising: (a) PVE lubricant; and (b) and a stabilizer according to any of Stabilizer 1 through Stabilizer 8. The lubricant according to this paragraph is sometimes referred to herein for convenience as Lubricant 3.

### DESCRIPTION

### Definitions

For the purposes of this invention, the term “about” in relation to temperatures in degrees centigrade (° C.) means that the stated temperature can vary by an amount of +/−5° C. In preferred embodiments, temperature specified as being about is preferably +/−2° C., more preferably +/−1° C., and even more preferably +/−0.5° C. of the identified temperature.

The phrase “Global Warming Potential” (hereinafter “GWP”) was developed to allow comparisons of the global warming impact of different gases. Specifically, it is a measure of how much energy the emission of one ton of a gas will absorb over a given period of time, relative to the emission of one ton of carbon dioxide. The larger the GWP, the more that a given gas warms the Earth compared to CO2 over that time period. The time period usually used for GWP is 100 years. GWP provides a common measure, which allows analysts to add up emission estimates of different gases. See www.epa.gov.

As the term is used herein, “replacement for” with respect to a particular heat transfer composition or refrigerant of the present invention as a “replacement for” a particular prior refrigerant means the use of the indicated composition of the present invention in a heat transfer system that heretofore had been commonly used with that prior refrigerant. By way of example, when a refrigerant or heat transfer composition of the present invention is used in a heat transfer system that has heretofore been designed for and/or commonly used with R410A, such as residential air conditioning and commercial air conditioning (including roof top systems, variable refrigerant flow (VRF) systems and chiller systems) then the present refrigerant is a replacement for R410A is such systems. The phrase “thermodynamic glide” applies to zeotropic refrigerant mixtures that have varying temperatures during phase change processes in the evaporator or condenser at constant pressure.

As the term is used herein, “TAN value” refers to the total acid number as determined in accordance with ASHRAE Standard 97—“Sealed Glass Tube Method to Test the Chemical Stability of Materials for Use within Refrigerant Systems” to simulate long-term stability of the heat transfer compositions by accelerated aging.

### Heat Transfer Compositions

Applicants have found that the heat transfer compositions of the present invention, including each of Heat Transfer Compositions 1-20 as described herein, are capable of providing exceptionally advantageous properties and in particular stability in use and non-flammability, especially with the use of the heat transfer compositions as a replacement for R-410A and especially in prior 410A residential air conditioning systems, and prior R-410A commercial air conditioning systems (including prior R-410A roof top systems, prior R-410A variable refrigerant flow (VRF) systems and prior R-410A chiller systems).

As used herein, the reference Heat Transfer Compositions 1-20 refers to each of Heat Transfer Compositions 1 through 20, including Heat Transfer Compositions 14A, 16A and 16B.

A particular advantage of the refrigerants included in the heat transfer compositions of the present invention is that they are non-flammable when tested in accordance with the Non-Flammability Test, and as mentioned above there has been a desire in the art to provide refrigerants and heat transfer compositions which can be used as a replacement for R-410A in various systems, and which has excellent heat transfer properties, low environmental impact (including particularly low GWP and near zero ODP), excellent chemical stability, low or no toxicity, and/or lubricant compatibility and which maintains non-flammability in use. This desirable advantage can be achieved by refrigerants and heat transfer compositions of the present invention.

Preferably, the heat transfer compositions of the present invention, including each of Heat Transfer Compositions 1-20, include refrigerant in an amount of greater than 40% by weight, or greater than 70% by weight, or greater than 80% by weight, or greater than 90% of the heat transfer composition.

Preferably, the heat transfer compositions of the present invention, including each of Heat Transfer Compositions 1-20, consist essentially of the refrigerant, the lubricant, including each of Lubricant 1-3, and a stabilizer of the present invention, including each of Stabilizer 1-8.

The heat transfer compositions of the invention may include other components for the purpose of enhancing or providing certain functionality to the compositions, preferably without negating the enhanced stability provided in accordance with present invention. Such other components or additives may include, dyes, solubilizing agents, compatibilizers, auxiliary stabilizers, antioxidants, corrosion inhibitors, extreme pressure additives and anti-wear additives.

### Co-Stabilizers:

It is contemplated that one or more of the following co-stabilizers may be included depending upon the application.

### Alkylated Naphthalenes

Applicants have surprisingly and unexpectedly found that alkylated naphthalenes are highly effective as stabilizers for the heat transfer compositions of the present invention. As used herein, the term “alkylated naphthalene” refers to compounds having the following structure:

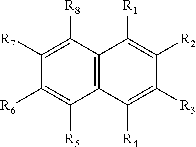

where each R₁-R₈ is independently selected from linear alkyl group, a branched alkyl group and hydrogen. The particular length of the alkyl chains and the mixtures or branched and straight chains and hydrogens can vary within the scope of the present invention, and it will be appreciated and understood by those skilled in the art that such variation is reflected the physical properties of the alkylated naphthalene, including in particular the viscosity of the alkylated compound, and producers of such materials frequently define the materials by reference to one or more of such properties as an alternative the specification of the particular R groups.

Applicants have found unexpected, surprising and advantageous results are associated the use of alkylated naphthalene as a stabilizer according to the present invention having the following properties, and alkylated naphthalene compounds having the indicated properties are referred to for convenience herein as Alkylated Naphthalene 1 (or AN1)—Alkylated Naphthalene 5 (or AN5) as indicated respectively in rows 1-5 in the Table below:

ALKYLATED NAPHTHALENE TABLE 1

| Property | AN1 | AN2 | AN3 | AN4 | AN5 |
|---|---|---|---|---|---|
| Viscosity | 20-200 | 20-100 | 20-50 | 30-40 | about 36 |
| @ 40° C. (ASTM | | | | | |
| D467), cSt | | | | | |
| Viscosity | 3-20 | 3-10 | 3-8 | 5-7 | about 5.6 |
| @ 100° C. | | | | | |
| (ASTM D467), cSt | | | | | |
| Pour Point | −50 to | −67 to | −40 to | −67 to −30 | about −33 |
| (ASTM D97), ° C. | −20 | −25 | −30 | | |

As used herein in connection with viscosity at 40° C. measured according to ASTM D467, the term “about” means +/−4 cSt.

As used herein in connection with viscosity at 100° C. measured according to ASTM D467, the term “about” means +/−0.4 cSt.

As used herein in connection with pour point as measured according to ASTM D97, the term “about” means +/−5° C.

Applicants have also found that unexpected, surprising and advantageous results are associated with the use of alkylated naphthalene as a stabilizer according to the present invention having the following properties, and alkylated naphthalene compounds having the indicated properties are referred to for convenience herein as Alkylated Naphthalene 6 (or AN6)—Alkylated Naphthalene 10 (or AN10) as indicated respectively in rows 6-10 in the Table below:

ALKYLATED NAPHTHALENE TABLE 2

| Property | AN6 | AN7 | AN 8 | AN 9 | AN10 |
|---|---|---|---|---|---|
| Viscosity | 20-200 | 20-100 | 20-50 | 30-40 | about 36 |
| @ 40° C. (ASTM D467), cSt | | | | | |
| Viscosity | 3-20 | 3-10 | 3-8 | 5-7 | about 5.6 |
| @ 100° C. | | | | | |
| (ASTM D467), cSt | | | | | |
| Aniline | 40-110 | 50-90 | 50-80 | 60-70 | about 36 |
| Point | | | | | |
| (ASTM D611), ° C. | | | | | |
| NoackVolatility | 1-50 | 5-30 | 5-15 | 10-15 | about 12 |
| CEC L40 | | | | | |
| (ASTM D6375), wt % | | | | | |
| Pour Point | −50 to −20 | −67 to −25 | −40 to | −67 to −30 | about −33 |
| (ASTM D97), ° C. | | | −30 | | |
| Flash Point | 200- | 200- | 220- | 230- | about 236 |
| (ASTM D92)), ° C. | 300 | 270 | 250 | 240 | |

Examples of alkylated naphthalenes within the meaning of Alkylated Naphthalene 1 and Alkylated Naphthalene 6 include those sold by King Industries under the trade designations NA-LUBE KR-007A; KR-008; KR-009; KR-015; KR-019; KR-005FG; KR-015FG; and KR-029FG.

Examples of alkylated naphthalenes within the meaning of Alkylated Naphthalene 2 and Alkylated Naphthalene 7 include those sold by King Industries under the trade designations NA-LUBE KR-007A; KR-008; KR-009; and KR-005FG.

An example of an alkylated naphthalene that is within the meaning of Alkylated Naphthalene 5 and Alkylated Naphthalene 10 includes the product sold by King Industries under the trade designation NA-LUBE KR-008.

The present invention includes heat transfer compositions, including each of Heat Transfer Compositions 1-20 hereof, wherein the stabilizer comprises an alkylated naphthalene, including each of AN1-AN10.

The present invention includes heat transfer compositions, including each of Heat Transfer Compositions 1-20 hereof, wherein the stabilizer comprises AN5.

Transfer Compositions 1-20 hereof, wherein the stabilizer comprises is AN10.

### Acid Depleting Moieties (ADM)

Those skilled in the art will be able to determine, without undo experimentation, a variety of ADMs that are useful in accordance with the present invention, and all such ADMs are within the scope hereof.

Other Epoxides

Applicants have found that epoxides, and particularly alkylated epoxides, are effective at producing the enhanced stability discussed herein when used in combination with alkylated naphthalene stabilizers, and while applicants are not necessarily bound by theory it is believed that this synergistic enhancement stems at least in part due to its effective functioning as an ADM in the heat transfer compositions of the present invention.

In preferred embodiments the epoxide is selected from the group consisting of epoxides that undergo ring-opening reactions with acids, thereby depleting the system of acid while not otherwise deleteriously affecting the system.

Useful epoxides include aromatic epoxides, alkyl epoxides, and alkenyl epoxides.

An example of a preferred epoxide useful as a co-stabilizer is 2-ethylhexyl glycidyl ether (also referred to herein as EHGE) having the following formula:

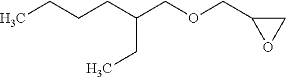

Preferred epoxides include epoxides of the following Formula I:

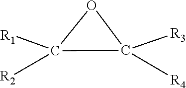

where at least one of said R₁-R₄ is selected from a two to fifteen carbon (C2-C15) acyclic group, a C2-C15 aliphatic group and a C2-C15 ethers. An epoxide according to Formula 1 is sometimes referred to herein for convenience as ADM1.

In a preferred embodiment, at least one of R1-R4 of Formula I is an ether having the following structure:

R₅—O—R₆

where each of R5 and R6 is independently a C1-C14 straight chain or branched chain, preferably unsubstituted, alkyl group. An epoxide according to the paragraph is sometimes referred to herein for convenience as ADM2.

In a preferred embodiment, one of R₁-R₄ of Formula I is an ether having the following structure:

R₅—O—R₆

where each of R₅ and R₆ is independently a C1-C14 straight chain or branched chain, preferably unsubstituted, alkyl group, and the remaining three of R₁-R₄ are H. An epoxide according to the paragraph is sometimes referred to herein for convenience as ADM3.

In preferred embodiments the epoxide comprises, consists essentially of or consists of 2-ethylhexyl glycidyl ether. An epoxide according to this paragraph is sometimes referred to herein for convenience as ADM4.

Carbodiimides

The ADM can include carbodiimides. In preferred embodiments the carbodiimides include compounds having the following structure:

R¹—N═C═N—R²

Other Stabilizers

It is contemplated that stabilizers other than the alkylated naphthalenes and ADM may be included in the heat transfer compositions of the present invention, including each of Heat Transfer Compositions 1-20. Examples of such other stabilizers are described hereinafter.

Phenol-Based Compounds

In preferred embodiments, the stabilizer further includes a phenol-based compound.

The phenol-based compound can be one or more compounds selected from 4,4′-methylenebis(2,6-di-tert-butylphenol); 4,4′-bis(2,6-di-tert-butylphenol); 2,2- or 4,4-biphenyldiols, including 4,4′-bis(2-methyl-6-tert-butylphenol); derivatives of 2,2- or 4,4-biphenyldiols; 2,2′-methylenebis(4-ethyl-6-tertbutylphenol); 2,2′-methylenebis(4-methyl-6-tert-butylphenol); 4,4-butylidenebis(3-methyl-6-tert-butylphenol); 4,4-isopropylidenebis(2,6-di-tert-butylphenol); 2,2′-methylenebis(4-methyl-6-nonylphenol); 2,2′-isobutylidenebis(4,6-dimethylphenol); 2,2′-methylenebis(4-methyl-6-cyclohexylphenol); 2,6-di-tert-butyl-4-methylphenol (BHT); 2,6-di-tert-butyl-4-ethylphenol: 2,4-dimethyl-6-tert-butylphenol; 2,6-di-tert-alpha-dimethylamino-p-cresol; 2,6-di-tert-butyl-4(N,N′-dimethylaminomethylphenol); 4,4′-thiobis(2-methyl-6-tert-butylphenol); 4,4′-thiobis(3-methyl-6-tert-butylphenol); 2,2′-thiobis(4-methyl-6-tert-butylphenol); bis(3-methyl-4-hydroxy-5-tert-butylbenzyl) sulfide; bis (3,5-di-tert-butyl-4-hydroxybenzyl)sulfide, tocopherol, hydroquinone, 2,2′6,6′-tetra-tert-butyl-4,4′-methylenediphenol and t-butyl hydroquinone, and preferably BHT.

The phenol compounds, and in particular BHT, can be provided in the heat transfer composition in an amount of greater than 0 and preferably from 0.0001% by weight to about 5% by weight, preferably 0.001% by weight to about 2.5% by weight, and more preferably from 0.01% to about 1% by weight. In each case, percentage by weight refers to the weight of the heat transfer composition.

The phenol compounds, and in particular BHT, can be provided in the heat transfer composition in an amount of greater than 0 and preferably from 0.0001% by weight to about 5% by weight, preferably 0.001% by weight to about 2.5% by weight, and more preferably from 0.01% to about 1% by weight. In each case, percentage by weight refers to the weight based on the weight of the lubricant in the heat transfer composition.

Diene-Based Compounds

The diene-based compounds include C3 to C15 dienes and to compounds formed by reaction of any two or more C3 to C4 dienes. Preferably, the diene-based compounds are selected from the group consisting of allyl ethers, propadiene, butadiene, isoprene, and terpenes. The diene-based compounds are preferably terpenes, which include but are not limited to terebene, retinal, geraniol, terpinene, delta-3 carene, terpinolene, phellandrene, fenchene, myrcene, farnesene, pinene, nerol, citral, camphor, menthol, limonene, nerolidol, phytol, carnosic acid, and vitamin A1. Preferably, the stabilizer is farnesene. Preferred terpene stabilizers are disclosed in U.S. Provisional Patent Application No. 60/638,003 filed on Dec. 12, 2004, published as US 2006/0167044A1, which is incorporated herein by reference.

In addition, the diene-based compounds can be provided in the heat transfer composition in an amount greater than 0 and preferably from 0.0001% by weight to about 5% by weight, preferably 0.001% by weight to about 2.5% by weight, and more preferably from 0.01% to about 1% by weight. In each case, percentage by weight refers to the weight of the heat transfer composition.

Phosphorus-Based Compounds

The phosphorus compound can be a phosphite or a phosphate compound. For the purposes of this invention, the phosphite compound can be a diaryl, dialkyl, friaryl and/or trialkyl phosphite, and/or a mixed aryl/alkyl di- or tri-substituted phosphite, in particular one or more compounds selected from hindered phosphites, tris-(di-tert-butylphenyl)phosphite, di-n-octyl phophite, iso-octyl diphenyl phosphite, iso-decyl diphenyl phosphite, tri-iso-decyl phosphate, triphenyl phosphite and diphenyl phosphite, particularly diphenyl phosphite. The phosphate compounds can be a triaryl phosphate, including tricresyl phosphate (also referred to herein as TCP), trialkyl phosphate, alkyl mono acid phosphate, aryl diacid phosphate, amine phosphate, preferably friaryl phosphate and/or a trialkyl phosphate, particularly tri-n-butyl phosphate.

The phosphorus compounds can be provided in the heat transfer composition in an amount of greater than 0 and preferably from 0.0001% by weight to about 5% by weight, preferably 0.001% by weight to about 2.5% by weight, and more preferably from 0.01% to about 1% by weight. In each case, by weight refers to weight of the heat transfer composition.

Nitrogen Compounds

When the stabilizer is a nitrogen compound, the stabilizer may comprise an amine-based compound such as one or more secondary or tertiary amines selected from diphenylamine, p-phenylenediamine, triethylamine, tributylamine, diisopropylamine, triisopropylamine and triisobutylamine. The amine based compound can be an amine antioxidant such as a substituted piperidine compound, i.e. a derivative of an alkyl substituted piperidyl, piperidinyl, piperazinone, or alkyoxypiperidinyl, particularly one or more amine antioxidants selected from 2,2,6,6-tetramethyl-4-piperidone, 2,2,6,6-tetramethyl-4-piperidinol; bis-(1,2,2,6,6-pentamethylpiperidyl)sebacate; di(2,2,6,6-tetramethyl-4-piperidyl)sebacate, poly(N-hydroxyethyl-2,2,6,6-tetramethyl-4-hydroxy-piperidyl succinate; alkylated paraphenylenediamines such as N-phenyl-N′-(1,3-dimethyl-butyl)-p-phenylenediamine or N,N′-di-sec-butyl-p-phenylenediamine and hydroxylamines such as tallow amines, methyl bis tallow amine and bis tallow amine, or phenol-alpha-napththylamine or Tinuvin®765 (Ciba), BLS®1944 (Mayzo Inc) and BLS® 1770 (Mayzo Inc). For the purposes of this invention, the amine-based compound also can be an alkyldiphenyl amine such as bis (nonylphenyl amine), dialkylamine such as (N-(1-methylethyl)-2-propylamine, or one or more of phenyl-alpha-naphthyl amine (PANA), alkyl-phenyl-alpha-naphthyl-amine (APANA), and bis (nonylphenyl) amine. Preferably the amine-based compound is one or more of phenyl-alpha-naphthyl amine (PANA), alkyl-phenyl-alpha-naphthyl-amine (APANA) and bis (nonylphenyl) amine, and more preferably phenyl-alpha-naphthyl amine (PANA).

Alternatively, or in addition to the nitrogen compounds identified above, one or more compounds selected from dinitrobenzene, nitrobenzene, nitromethane, nitrosobenzene, and TEMPO [(2,2,6,6-tetramethylpiperidin-1-yl)oxyl] may be used as the stabilizer. The nitrogen compounds can be provided in the heat transfer composition in an amount of greater than 0 and from 0.0001% by weight to about 5% by weight, preferably 0.001% by weight to about 2.5% by weight, and more preferably from 0.01% to about 1% by weight. In each case, percentage by weight refers to the weight of the heat transfer composition.

Isobutylene

Isobutylene may also be used as a stabilizer according to the present invention.

### Lubricants

In general, the heat transfer composition of the present invention, including each of Heat Transfer Compositions 1-20, comprises a POE lubricant and/or a PVE lubricant wherein the lubricant is present in amounts preferably of from about 0.1% by weight to about 5%, or from 0.1% by weight to about 1% by weight, or from 0.1% by weight to about 0.5% by weight, based on the weight of the heat transfer composition.

POE Lubricants

The POE lubricant of the present invention includes in preferred embodiments a neopentyl POE lubricant. As used herein, the term neopentyl POE lubricant refers to polyol esters (POEs) derived from a reaction between a neopentyl polyol (preferably pentaerythritol, trimethylolpropane, or neopentyl glycol, and in embodiments where higher viscosities are preferred, dipentaerythritol) and a linear or branched carboxylic acid.

Commercially available POEs include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred pentaerythritol derivative POE lubricants having the properties identified below:

| Property | RL32-3MAF | RL68H |
|---|---|---|
| Viscosity | about 31 | about 67 |
| @ 40° C. (ASTM D467), cSt | | |
| Viscosity | about 5.6 | about 9.4 |
| @ 100° C. (ASTM D467), cSt | | |
| Pour Point | about −40 | about −40 |
| (ASTM D97), ° C. | | |

Other useful esters include phosphate esters, di-basic acid esters and fluoro esters.

A lubricant consisting essentially of a POE having a viscosity at 40° C. measured in accordance with ASTM D445 of from about 30 cSt to about 70 cSt and a viscosity Measured @100° C. in accordance with ASTM D445 of from about 5 cSt to about 10 cSt is referred to herein as Lubricant 4.

A lubricant consisting essentially of a neopentyl POE having a viscosity at 40° C. measured in accordance with ASTM D467 of from about 30 cSt to about 70 cSt is referred to for convenience as Lubricant 5.

In preferred embodiments, the present Heat Transfer Compositions, including each of Heat Transfer Compositions 1-20, comprise a POE lubricant.

In preferred embodiments, the present Heat Transfer Compositions, including each of Heat Transfer Compositions 1-20, comprise lubricant consisting essentially of a POE lubricant.

In preferred embodiments, the present Heat Transfer Compositions, including each of Heat Transfer Compositions 1-20, comprise lubricant consisting of a POE lubricant.

A preferred heat transfer composition comprises Heat Transfer Composition 1-20 wherein the lubricant is any one of Lubricant 1 through Lubricant 5.

PVE Lubricants

The lubricant of the present invention can include PVE lubricants generally. In preferred embodiments the PVE lubricant is as PVE according to Formula II below:

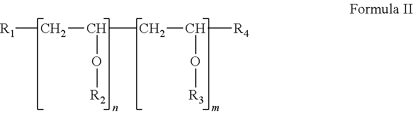

where R₂ and R₃ are each independently C1-C10 hydrocarbons, preferably C2-C8 hydrocarbons, and R₁ and R₄ are each independently alkyl, alkylene glycol, or polyoxyalkylene glycol units and n and m are selected preferably according to the needs of those skilled in the art to obtain a lubricant with the desired properties, and preferable n and m are selected to obtain a lubricant with a viscosity at 40° C. measured in accordance with ASTM D467 of from about 30 to about 70 cSt. A PVE lubricant according to the description immediately above is referred to for convenience as Lubricant 6A. Commercially available polyvinyl ethers include those lubricants sold under the trade designations FVC32D and FVC68D, from Idemitsu.

In preferred embodiments, the PVE lubricant in accordance with the present invention has properties within about the range of values described below, it being understood that the indicted values are each preceded by “about.”

| Lubricant | Lubricant | Broad | Intermediate | Narrow |
|---|---|---|---|---|
| Designation | Property | Range | Range | Range |
| 6B | Viscosity | 20-90 | 25-85 | 30-70 |
| | (mm2/sec), 40° C. | | | |
| | Viscosity | 3-12 | 4-10 | 5-9 |
| | (mm2/sec), 100° C. | | | |
| | Viscosity index | 65-95 | 70-90 | 75-85 |
| | Pour point (° C.) | −60-−25 | −65-−30 | −50-−35 |
| 6C | Viscosity | 20-50 | 25-40 | 25-35 |
| | (mm2/sec), 40° C. | | | |
| | Viscosity | 2-8 | 3-7 | 4-6 |
| | (mm2/sec), 100° C. | | | |
| | Viscosity index | 70-80 | 72-80 | 75-80 |
| | Pour point (° C.) | −55-−40 | −50-−40 | −50-−45 |
| 6D | Viscosity | 60-75 | 60-70 | 65-70 |
| | (mm2/sec), 40° C. | | | |
| | Viscosity | 7-9 | 7.5-9 | 7.5-8.5 |
| | (mm2/sec), 100° C. | | | |
| | Viscosity index | 75-90 | 80-90 | 80-85 |
| | Pour point (° C.) | −45-−30 | −40-−30 | −40-−35 |

In preferred embodiments, the present Heat Transfer Compositions, including each of Heat Transfer Compositions 1-20, comprise a PVE lubricant.

In preferred embodiments, the present Heat Transfer Compositions, including each of Heat Transfer Compositions 1-20, comprise lubricant consist essentially of a PVE lubricant.

In preferred embodiments, the present Heat Transfer Compositions, including each of Heat Transfer Compositions 1-20, comprise lubricant consisting of a PVE lubricant.

In preferred embodiments, the PVE in the present Heat Transfer Compositions, including each of Heat Transfer Compositions 1-20, is a PVE according to Formula II.

In preferred embodiments, the present Heat Transfer Compositions, including each of Heat Transfer Compositions 1-20, comprise lubricant consist essentially of Lubricant 6A.

In preferred embodiments, the present Heat Transfer Compositions, including each of Heat Transfer Compositions 1-20, comprise lubricant consist essentially of Lubricant 6B.

In preferred embodiments, the present Heat Transfer Compositions, including each of Heat Transfer Compositions 1-20, comprise lubricant consist essentially of Lubricant 6C.

Stabilized Lubricants

The present invention also provides stabilized lubricants comprising: (a) POE lubricant; and (b) a stabilizer of the present invention, including each of Stabilizers 1-20.

The stabilized lubricant according to this paragraph is sometimes referred to herein for convenience as Stabilized Lubricant 1.

The present invention also provides stabilized lubricants comprising: (a) neo pentyl POE lubricant; and (b) a stabilizer of the present invention, including each of Stabilizers 1-8. The stabilized lubricant according to this paragraph is sometimes referred to herein for convenience as Stabilized Lubricant 2.

The present invention also provides stabilized lubricants comprising: (a) Lubricant 4; and (b) a stabilizer of the present invention, including each of Stabilizers 1-20. The stabilized lubricant according to this paragraph is sometimes referred to herein for convenience as Stabilized Lubricant 3.

The present invention also provides stabilized lubricants comprising: (a) Lubricant 5; and (b) a stabilizer of the present invention, including each of Stabilizers 1-20. The stabilized lubricant according to this paragraph is sometimes referred to herein for convenience as Stabilized Lubricant 4.

The present invention also provides stabilized lubricants comprising: (a) Lubricant 6A; and (b) a stabilizer of the present invention, including each of Stabilizers 1-20. The stabilized lubricant according to this paragraph is sometimes referred to herein for convenience as Stabilized Lubricant 5A.

The present invention also provides stabilized lubricants comprising: (a) Lubricant 6B; and (b) a stabilizer of the present invention, including each of Stabilizers 1-20. The stabilized lubricant according to this paragraph is sometimes referred to herein for convenience as Stabilized Lubricant 5B.

The present invention also provides stabilized lubricants comprising: (a) Lubricant 6C; and (b) a stabilizer of the present invention, including each of Stabilizers 1-20. The stabilized lubricant according to this paragraph is sometimes referred to herein for convenience as Stabilized Lubricant 5C.

The present invention also provides stabilized lubricants comprising: (a) PVE Lubricant; and (b) a stabilizer of the present invention, including each of Stabilizers 1-20. The stabilized lubricant according to this paragraph is sometimes referred to herein for convenience as Stabilized Lubricant 5D.

### Methods, Uses and Systems

The heat transfer compositions disclosed herein are provided for use in heat transfer applications, including air conditioning applications, with highly preferred air conditioning applications including residential air conditioning, commercial air conditioning applications (such as roof top applications, VRF applications and chillers).

The present invention also includes methods for providing heat transfer including methods of air conditioning, with highly preferred air conditioning methods including providing residential air conditioning, providing commercial air conditioning (such as methods of providing roof top air conditioning, methods of providing VRF air conditioning and methods of providing air conditioning using chillers).

The present invention also includes heat transfer systems, including air conditioning systems, with highly preferred air conditioning systems including residential air conditioning, commercial air conditioning systems (such as roof top air conditioning systems, VRF air conditioning systems and air conditioning chiller systems).

The invention also provides uses of the heat transfer compositions, methods using the heat transfer compositions and systems containing the heat transfer compositions in connection with refrigeration, heat pumps and chillers (including portable water chillers and central water chillers).

Any reference to the heat transfer composition of the invention refers to each and any of the heat transfer compositions as described herein. Thus, for the following discussion of the uses, methods, systems or applications of the composition of the invention, the heat transfer composition may comprise or consist essentially of any of Heat Transfer Compositions 1-20, including any of Heat Transfer Compositions using any of Stabilized Lubricants 1-6.

For heat transfer systems of the present invention that include a compressor and lubricant for the compressor in the system, the system can comprises a loading of refrigerant and lubricant such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

The heat transfer systems according to the present invention can comprise a compressor, an evaporator, a condenser and an expansion device, in fluid communication with each other, a Heat Transfer Compositions 1-20 and a sequestration material in the system, wherein said sequestration material preferably comprises: i. copper or a copper alloy, or ii. activated alumina, or iii. a zeolite molecular sieve comprising copper, silver, lead or a combination thereof, or iv. an anion exchange resin, or v. a moisture-removing material, preferably a moisture-removing molecular sieve, or vi. a combination of two or more of the above.

The present invention also includes methods for transferring heat of the type comprising evaporating refrigerant liquid to produce a refrigerant vapor, compressing in a compressor at least a portion of the refrigerant vapor and condensing refrigerant vapor in a plurality of repeating cycles, said method comprising:

(a) providing a heat transfer composition according to the present invention, including each of Heat Transfer Compositions 1-20;

(b) optionally but preferably providing lubricant for said compressor; and

(b) exposing at least a portion of said refrigerant and/or at least a portion of said lubricant to a sequestration material.

### Uses, Equipment and Systems

The present invention includes vapor compression heat transfer systems, including operating heat transfer systems, that comprise a heat transfer composition of the present invention, including each of Heat Transfer Compositions 1-20. The heat transfer systems according to this paragraph are sometimes referred to herein for convenience as Heat Transfer System 1.

The present invention includes vapor compression heat transfer systems, including operating heat transfer systems, which comprise a heat transfer composition of the present invention, including each of Heat Transfer Compositions 1-20 and wherein the lubricant is Lubricant 4. The heat transfer systems according to this paragraph are sometimes referred to herein for convenience as Heat Transfer System 2.

The present invention includes vapor compression heat transfer systems, including operating heat transfer systems, which comprise a heat transfer composition of the present invention, including each of Heat Transfer Compositions 1-20 and wherein the lubricant is Lubricant 5. The heat transfer systems according to this paragraph are sometimes referred to herein for convenience as Heat Transfer System 3.

The present invention includes vapor compression heat transfer systems, including operating heat transfer systems, which comprise a heat transfer composition of the present invention, including each of Heat Transfer Compositions 1-20 and wherein the lubricant is RL32-3MAF. The heat transfer systems according to this paragraph are sometimes referred to herein for convenience as Heat Transfer System 4.

The present invention includes vapor compression heat transfer systems, including operating heat transfer systems, which comprise a heat transfer composition of the present invention, including each of Heat Transfer Compositions 1-20 and wherein the lubricant is RL68H. The heat transfer systems according to this paragraph are sometimes referred to herein for convenience as Heat Transfer System 5.

The present invention includes vapor compression heat transfer systems, including operating heat transfer systems, which comprise a heat transfer composition of the present invention, including each of Heat Transfer Compositions 1-20 and wherein the lubricant is Lubricant 6A. The heat transfer systems according to this paragraph are sometimes referred to herein for convenience as Heat Transfer System 6.

The present invention includes vapor compression heat transfer systems, including operating heat transfer systems, which comprise a heat transfer composition of the present invention, including each of Heat Transfer Compositions 1-20 and wherein the lubricant is Lubricant 6B. The heat transfer systems according to this paragraph are sometimes referred to herein for convenience as Heat Transfer System 7.

The present invention includes vapor compression heat transfer systems, including operating heat transfer systems, which comprise a heat transfer composition of the present invention, including each of Heat Transfer Compositions 1-20 and wherein the lubricant is Lubricant 6C. The heat transfer systems according to this paragraph are sometimes referred to herein for convenience as Heat Transfer System 8.

The present invention includes vapor compression heat transfer systems, including operating heat transfer systems, which comprise a heat transfer composition of the present invention, including each of Heat Transfer Compositions 1-20 and wherein the lubricant is FVC32D. The heat transfer systems according to this paragraph are sometimes referred to herein for convenience as Heat Transfer System 9.

The present invention includes vapor compression heat transfer systems, including operating heat transfer systems, which comprise a heat transfer composition of the present invention, including each of Heat Transfer Compositions 1-20 and wherein the lubricant is FVC68D. The heat transfer systems according to this paragraph are sometimes referred to herein for convenience as Heat Transfer System 10.

In certain preferred embodiments, the heat transfer systems of the present invention, including each of Heat Transfer Systems 1-10, comprise a compressor that is essentially free of zinc-containing components. The heat transfer systems according to this paragraph are sometimes referred to herein for convenience as Heat Transfer System 11.

In certain preferred embodiments, the heat transfer systems of the present invention, including each of Heat Transfer Systems 1-10, comprise a compressor that is essentially free of zinc-containing components exposed to lubricant during operation. The heat transfer systems according to this paragraph are sometimes referred to herein for convenience as Heat Transfer System 12.

In certain preferred embodiments, the heat transfer systems of the present invention, including each of Heat Transfer Systems 1-10, comprise a compressor that is essentially free of zinc-containing components exposed to lubricant that is a temperature of about 100° F. or greater during operation. The heat transfer systems according to this paragraph are sometimes referred to herein for convenience as Heat Transfer System 13.

In preferred embodiments, the heat transfer systems of the present invention, including each of Heat Transfer Systems 1-13, include residential air conditioning systems and methods have refrigerant evaporating temperatures in the range of from about 0° C. to about 10° C. and the condensing temperature is in the range of about 40° C. to about 70° C.

In preferred embodiments, the heat transfer systems of the present invention, including each of Heat Transfer Systems 1-13, include residential air conditioning systems and methods used in a heating mode have refrigerant evaporating temperatures in the range of from about −20° C. to about 3° C. and the condensing temperature is in the range of about 35° C. to about 50° C.

In preferred embodiments, the heat transfer systems of the present invention, including each of Heat Transfer Systems 1-13, include commercial air conditioning systems and methods have refrigerant evaporating temperatures in the range of from about 0° C. to about 10° C. and the condensing temperature is in the range of about 40° C. to about 70° C.

In preferred embodiments, the heat transfer systems of the present invention, including each of Heat Transfer Systems 1-13, include hydronic system systems and methods have refrigerant evaporating temperatures in the range of from about −20° C. to about 3° C. and the condensing temperature is in the range of about 50° C. to about 90° C.

In preferred embodiments, the heat transfer systems of the present invention, including each of Heat Transfer Systems 1-13, include medium temperature systems and methods have refrigerant evaporating temperatures in the range of from about −12° C. to about 0° C. and the condensing temperature is in the range of about 40° C. to about 70° C.

In preferred embodiments, the heat transfer systems of the present invention, including each of Heat Transfer Systems 1-13, include low temperature systems and methods have refrigerant evaporating temperatures in the range of from about −40° C. to about −12° C. and the condensing temperature is in the range of about 40° C. to about 70° C.

In preferred embodiments, the heat transfer systems of the present invention, including each of Heat Transfer Systems 1-13, include rooftop air conditioning systems and methods have refrigerant evaporating temperatures in the range of from about 0° C. to about 10° C. and the condensing temperature is in the range of about 40° C. to about 70° C.

In preferred embodiments, the heat transfer systems of the present invention, including each of Heat Transfer Systems 1-13, include VRF systems and methods have refrigerant evaporating temperatures in the range of from about 0° C. to about 10° C. and the condensing temperature is in the range of about 40° C. to about 70° C.

The present invention includes the use of any of Heat Transfer Compositions 1-20 in a residential air conditioning system.

The present invention therefore includes t the use of any of Heat Transfer Compositions 1-20 in a chiller system.

Examples of commonly used compressors, for the purposes of this invention include reciprocating, rotary (including rolling piston and rotary vane), scroll, screw, and centrifugal compressors. Thus, the present invention provides each and any of the refrigerants and/or heat transfer compositions as described herein for use in a heat transfer system comprising a reciprocating, rotary (including rolling piston and rotary vane), scroll, screw, or centrifugal compressor.

Examples of commonly used expansion devices, for the purposes of this invention include a capillary tube, a fixed orifice, a thermal expansion valve and an electronic expansion valve. Thus, the present invention provides each and any of the refrigerants and/or heat transfer compositions as described herein for use in a heat transfer system comprising a capillary tube, a fixed orifice, a thermal expansion valve or an electronic expansion valve.

For the purposes of this invention, the evaporator and the condenser can each be in the form a heat exchanger, preferably selected from a finned tube heat exchanger, a microchannel heat exchanger, a shell and tube, a plate heat exchanger, and a tube-in-tube heat exchanger. Thus, the present invention provides each and any of the refrigerants and/or heat transfer compositions as described herein for use in a heat transfer system wherein the evaporator and condenser together form a finned tube heat exchanger, a microchannel heat exchanger, a shell and tube, a plate heat exchanger, or a tube-in-tube heat exchanger.

The systems of the present invention, including each of Heat Transfer Systems 1-13, thus preferably include a sequestration material in contact with at least a portion of a refrigerant and/or at least a portion of a the lubricant according to the present invention wherein the temperature of said sequestration material and/or the temperature of said refrigerant and/or the temperature of said lubricant when in said contact are at a temperature that is preferably at least about 10 C wherein the sequestration material preferably comprises a combination of: an anion exchange resin, activated alumina, a zeolite molecular sieve comprising silver, and a moisture-removing material, preferably a moisture-removing molecular sieve.

As used in this application, the term “in contact with at least a portion” is intended in its broad sense to include each of said sequestration materials and any combination of sequestration materials being in contact with the same or separate portions of the refrigerant and/or the lubricant in the system and is intended to include but not necessarily limited to embodiments in which each type or specific sequestration material is: (i) located physically together with each other type or specific material, if present; (ii) is located physically separate from each other type or specific material, if present, and (iii) combinations in which two or more materials are physically together and at least one sequestration material is physically separate from at least one other sequestration material.

The heat transfer composition of the invention can be used in heating and cooling applications.

In a particular feature of the invention, the heat transfer composition can be used in a method of cooling comprising condensing a heat transfer composition and subsequently evaporating said composition in the vicinity of an article or body to be cooled.

Thus, the invention relates to a method of cooling in a heat transfer system comprising an evaporator, a condenser and a compressor, the process comprising i) condensing a heat transfer composition as described herein; and

ii) evaporating the composition in the vicinity of body or article to be cooled; wherein the evaporator temperature of the heat transfer system is in the range of from about −40° C. to about +10° C.

Alternatively, or in addition, the heat transfer composition can be used in a method of heating comprising condensing the heat transfer composition in the vicinity of an article or body to be heated and subsequently evaporating said composition.

Thus, the invention relates to a method of heating in a heat transfer system, including each of Heat Transfer Systems 1-13, comprising an evaporator, a condenser and a compressor, the process comprising i) condensing a heat transfer composition as described herein, in the vicinity of a body or article to be heated and ii) evaporating the composition; wherein the evaporator temperature of the heat transfer system is in the range of about −30° C. to about 5° C.

The heat transfer composition of the invention is provided for use in air conditioning applications including both transport and stationary air conditioning applications. Thus, any of the heat transfer compositions described herein can be used in any one of:
an air conditioning application including mobile air conditioning, particularly in trains and buses conditioning,
a mobile heat pump, particularly an electric vehicle heat pump;
a chiller, particularly a positive displacement chiller, more particularly an air cooled or water-cooled direct expansion chiller, which is either modular or conventionally singularly packaged,
a residential air conditioning system, particularly a ducted split or a ductless split air conditioning system,
a residential heat pump,
a residential air to water heat pump/hydronic system,
an industrial air conditioning system
a commercial air conditioning system, particularly a packaged rooftop unit and a variable refrigerant flow (VRF) system;
a commercial air source, water source or ground source heat pump system.

The heat transfer composition of the invention is provided for use in a refrigeration system. The term “refrigeration system” refers to any system or apparatus or any part or portion of such a system or apparatus which employs a refrigerant to provide cooling. Thus, any of the heat transfer compositions described herein can be used, in a heat transfer system of the present invention, including each of Heat Transfer Systems 1-13, in the form of any one of:
a low temperature refrigeration system,
a medium temperature refrigeration system,
a commercial refrigerator,
a commercial freezer,
an ice machine,
a vending machine,
a transport refrigeration system,
a domestic freezer,
a domestic refrigerator,
an industrial freezer,
an industrial refrigerator and
a chiller.

Each of the heat transfer compositions described herein, including Heat Transfer Compositions 1-20, is particularly provided for use in a residential air-conditioning system (with an evaporator temperature in the range of about 0 to about 10° C., particularly about 7° C. for cooling and/or in the range of about −20 to about 3° C., particularly about 0.5° C. for heating). Alternatively, or additionally, each of the heat transfer compositions described herein, including each of Heat Transfer Compositions 1-20, is particularly provided for use in a residential air conditioning system with a reciprocating, rotary (rolling-piston or rotary vane) or scroll compressor.

Each of the heat transfer compositions described, including Heat Transfer Compositions 1-20, is particularly provided for use in an air-cooled chiller (with an evaporator temperature in the range of about 0 to about 10° C., particularly about 4.5° C.), particularly an air-cooled chiller with a positive displacement compressor, more particular an air-cooled chiller with a reciprocating scroll compressor.

Each of the heat transfer compositions described herein, including Heat Transfer Compositions 1-20, is particularly provided for use in a residential air to water heat pump hydronic system (with an evaporator temperature in the range of about −20 to about 3° C., particularly about 0.5° C. or with an evaporator temperature in the range of about −30 to about 5° C., particularly about 0.5° C.).

Each of the heat transfer compositions described herein, including Heat Transfer Compositions 1-20, is particularly provided for use in a medium temperature refrigeration system (with an evaporator temperature in the range of about −12 to about 0° C., particularly about −8° C.).

Each of the heat transfer compositions described herein, including Heat Transfer Compositions 1-20, is particularly provided for use in a low temperature refrigeration system (with an evaporator temperature in the range of about −40° C. to about −12° C., particularly about from about −40° C. to about −23° C. or preferably about −32° C.).

The heat transfer composition of the invention, including Heat Transfer Compositions 1-20, is provided for use in a residential air conditioning system, wherein the residential air-conditioning system is used to supply cool air (said air having a temperature of for example, about 10° C. to about 17° C., particularly about 12° C.) to buildings for example, in the summer.

The heat transfer composition of the invention, including Heat Transfer Compositions 1-20, is thus provided for use in a split residential air conditioning system, wherein the residential air-conditioning system is used to supply cool air (said air having a temperature of for example, about 10° C. to about 17° C., particularly about 12° C.).

The heat transfer composition of the invention, including Heat Transfer Compositions 1-20, is thus provided for use in a ducted split residential air conditioning system, wherein the residential air-conditioning system is used to supply cool air (said air having a temperature of for example, about 10° C. to about 17° C., particularly about 12° C.).

The heat transfer composition of the invention, including Heat Transfer Compositions 1-20, is thus provided for use in a window residential air conditioning system, wherein the residential air-conditioning system is used to supply cool air (said air having a temperature of for example, about 10° C. to about 17° C., particularly about 12° C.).

The heat transfer composition of the invention, including Heat Transfer Compositions 1-20, is thus provided for use in a portable residential air conditioning system, wherein the residential air-conditioning system is used to supply cool air (said air having a temperature of for example, about 10° C. to about 17° C., particularly about 12° C.).

The residential air conditioning systems as described herein, including in the immediately preceding paragraphs, preferably have an air-to-refrigerant evaporator (indoor coil), a compressor, an air-to-refrigerant condenser (outdoor coil), and an expansion valve. The evaporator and condenser can be round tube plate fin, a finned tube or microchannel heat exchanger. The compressor can be a reciprocating or rotary (rolling-piston or rotary vane) or scroll compressor. The expansion valve can be a capillary tube, thermal or electronic expansion valve. The refrigerant evaporating temperature is preferably in the range of 0° C. to 10° C. The condensing temperature is preferably in the range of 40° C. to 70° C.

The heat transfer composition of the invention, including Heat Transfer Compositions 1-20, is provided for use in a residential heat pump system, wherein the residential heat pump system is used to supply warm air (said air having a temperature of for example, about 18° C. to about 24° C., particularly about 21° C.) to buildings in the winter. It can be the same system as the residential air-conditioning system, while in the heat pump mode the refrigerant flow is reversed, and the indoor coil becomes condenser, and the outdoor coil becomes evaporator. Typical system types are split and mini-split heat pump system. The evaporator and condenser are usually a round tube plate fin, a finned or microchannel heat exchanger. The compressor is usually a reciprocating or rotary (rolling-piston or rotary vane) or scroll compressor. The expansion valve is usually a thermal or electronic expansion valve. The refrigerant evaporating temperature is preferably in the range of about −20° C. to about 3° C. or about −30° C. to about 5° C. The condensing temperature is preferably in the range of about 35° C. to about 50° C.

The heat transfer composition of the invention, including Heat Transfer Compositions 1-20, is provided for use in a commercial air-conditioning system wherein the commercial air conditioning system can be a chiller which is used to supply chilled water (said water having a temperature of for example about 7° C.) to large buildings such as offices and hospitals, etc. Depending on the application, the chiller system may be running all year long. The chiller system may be air-cooled or water-cooled. The air-cooled chiller usually has a plate, tube-in-tube or shell-and-tube evaporator to supply chilled water, a reciprocating or scroll compressor, a round tube plate fin, a finned tube or microchannel condenser to exchange heat with ambient air, and a thermal or electronic expansion valve. The water-cooled system usually has a shell-and-tube evaporator to supply chilled water, a reciprocating, scroll, screw or centrifugal compressor, a shell-and-tube condenser to exchange heat with water from cooling tower or lake, sea and other natural recourses, and a thermal or electronic expansion valve. The refrigerant evaporating temperature is preferably in the range of about 0° C. to about 10° C. The condensing temperature is preferably in the range of about 40° C. to about 70° C.

The heat transfer composition of the invention, including Heat Transfer Compositions 1-20, is provided for use in a residential air-to-water heat pump hydronic system, wherein the residential air-to-water heat pump hydronic system is used to supply hot water (said water having a temperature of for example about 50° C. or about 55° C.) to buildings for floor heating or similar applications in the winter. The hydronic system usually has a round tube plate fin, a finned tube or microchannel evaporator to exchange heat with ambient air, a reciprocating, scroll or rotary compressor, a plate, tube-in-tube or shell-in-tube condenser to heat the water, and a thermal or electronic expansion valve. The refrigerant evaporating temperature is preferably in the range of about −20 to about 3° C., or −30 to about 5° C. The condensing temperature is preferably in the range of about 50° C. to about 90° C.

The heat transfer composition of the invention, including Heat Transfer Compositions 1-20, is provided for use in a medium temperature refrigeration system, wherein the refrigerant has and evaporating temperature preferably in the range of about −12° C. to about 0° C., and in such systems the refrigerant has a condensing temperature preferably in the range of about 40° C. to about 70° C., or about 20° C. to about 70° C.

The present invention thus provides a medium temperature refrigeration system used to chill food or beverages, such as in a refrigerator or a bottle cooler, wherein the refrigerant has an evaporating temperature preferably in the range of about −12° C. to about 0° C., and in such systems the refrigerant has a condensing temperature preferably in the range of about 40° C. to about 70° C., or about 20° C. to about 70° C.

The medium temperature systems of the present invention, including the systems as described in the immediately preceding paragraphs, preferably have an air-to-refrigerant evaporator to provide chilling, for example to the food or beverage contained therein, a reciprocating, scroll or screw or rotary compressor, an air-to-refrigerant condenser to exchange heat with the ambient air, and a thermal or electronic expansion valve. The heat transfer composition of the invention, including Heat Transfer Compositions 1-20, is provided for use in a low temperature refrigeration system, wherein the refrigerant has an evaporating temperature that is preferably in the range of about −40° C. to about −12° C. and the refrigerant has a condensing temperature that is preferably in the range of about 40° C. to about 70° C., or about 20° C. to about 70° C.

The present invention thus provides a low temperature refrigeration system used to provide cooling in a freezer wherein the refrigerant has an evaporating temperature that is preferably in the range of about −40° C. to about −12° C. and the refrigerant has a condensing temperature that is preferably in the range of about 40° C. to about 70° C., or about 20 to about 70° C.

The present invention thus also provides a low temperature refrigeration system used to provide cooling in an cream machine refrigerant has an evaporating temperature that is preferably in the range of about −40° C. to about −12° C. and the refrigerant has a condensing temperature that is preferably in the range of about 40° C. to about 70° C., or about 20° C. to about 70° C.

The low temperature systems of the present invention, including the systems as described in the immediately preceding paragraphs, preferably have an air-to-refrigerant evaporator to chill the food or beverage, a reciprocating, scroll or rotary compressor, an air-to-refrigerant condenser to exchange heat with the ambient air, and a thermal or electronic expansion valve.

For the purposes of this invention, each heat transfer composition in accordance with the present invention, including each of Heat Transfer Compositions 1-20, is provided for use in a chiller with an evaporating temperature in the range of about 0° C. to about 10° C. and a condensing temperature in the range of about 40° C. to about 70° C. The chiller is provided for use in air conditioning or refrigeration, and preferably for commercial air conditioning. The chiller is preferably a positive displacement chiller, more particularly an air cooled or water-cooled direct expansion chiller, which is either modular or conventionally singularly packaged.

The present invention therefore provides the use of each heat transfer composition in accordance with the present invention, including each of Heat Transfer Compositions 1-20, in stationary air conditioning, particularly residential air conditioning, industrial air conditioning or commercial air conditioning.

Each heat transfer composition in accordance with the present invention, including each of Heat Transfer Compositions 1-20, is provided as a low GWP replacement for the refrigerant R-410A.

Each heat transfer composition in accordance with the present invention, including each of Heat Transfer Compositions 1-20, is provided as a low GWP retrofit for the refrigerant R-410A.

The heat transfer compositions and the refrigerants of the present invention, including each of Heat Transfer Compositions 1-20, therefore can be used as a retrofit refrigerant/heat transfer composition or as a replacement refrigerant/heat transfer composition.

The present invention thus includes methods of retrofitting existing heat transfer system designed for and containing R-410A refrigerant, without requiring substantial engineering modification of the existing system, particularly without modification of the condenser, the evaporator and/or the expansion valve.

The present invention thus also includes methods of using a refrigerant or heat transfer composition of the present invention as a replacement for R-410A, and in particular as a replacement for R-410A in residential air conditioning refrigerant, without requiring substantial engineering modification of the existing system, particularly without modification of the condenser, the evaporator and/or the expansion valve.

The present invention thus also includes methods of using a refrigerant or heat transfer composition of the present invention as a replacement for R-410A, and in particular as a replacement for R-410A in a residential air conditioning system.

The present invention thus also includes methods of using a refrigerant or heat transfer composition of the present invention as a replacement for R-410A, and in particular as a replacement for R-410A in a chiller system.

There is therefore provided a method of retrofitting an existing heat transfer system that contains R-410A refrigerant, said method comprising replacing at least a portion of the existing R-410A refrigerant with a heat transfer composition of the present invention, including each of Heat Transfer Compositions 1-20.

The step of replacing preferably comprises removing at least a substantial portion of, and preferably substantially all of, the existing refrigerant (which can be but is not limited to R-410A) and introducing a heat transfer composition, including each of Heat Transfer Compositions 1-20, without any substantial modification of the system to accommodate the refrigerant of the present invention. Preferably, the method comprises removing at least about 5%, about 10%, about 25%, about 50%, or about 75% by weight of the R-410A from the system and replacing it with the heat transfer compositions of the invention.

Alternatively, the heat transfer composition can be used in a method of retrofitting an existing heat transfer system designed to contain or containing R410A refrigerant, wherein the system is modified for use with a Heat Transfer Composition of the present invention.

Alternatively, the heat transfer composition can be used as a replacement in a heat transfer system which is designed to contain or is suitable for use with R-410A refrigerant.

It will be appreciated that the invention encompasses the use of the heat transfer compositions of the invention, including each of Heat Transfer Compositions 1-17, as a low Global Warming replacement for R-410A or is used in a method of retrofitting an existing heat transfer system or is used in a heat transfer system which is suitable for use with R-410A refrigerant as described herein.

It will be appreciated by the skilled person that when the heat transfer composition is provided for use in a method of retrofitting an existing heat transfer system as described above, the method preferably comprises removing at least a portion of the existing R-410A refrigerant from the system. Preferably, the method comprises removing at least about 5%, about 10%, about 25%, about 50% or about 75% by weight of the R-410A from the system and replacing it with the heat transfer compositions of the invention, including each of Heat Transfer Compositions 1-20.

The heat transfer compositions of the invention may be employed as a replacement in systems which are used or are suitable for use with R-410A refrigerant, such as existing or new heat transfer systems.

The compositions of the present invention exhibit many of the desirable characteristics of R-410A but have a GWP that is substantially lower than that of R-410A while at the same time having operating characteristics i.e., capacity and/or efficiency (COP) that are substantially similar to or substantially match, and preferably are as high as or higher than R-410A. This allows the claimed compositions to replace R-410A in existing heat transfer systems without requiring any significant system modification for example of the condenser, the evaporator and/or the expansion valve. The composition can therefore be used as a direct replacement for R-410A in heat transfer systems.

The heat transfer compositions of the invention therefore preferably exhibit operating characteristics compared with R-410A wherein the efficiency (COP) of the composition is greater than 90% of the efficiency of R-410A in the heat transfer system.

The heat transfer composition of the invention therefore preferably exhibits operating characteristics compared with R-410A wherein the capacity is from 95 to 105% of the capacity of R-410A in the heat transfer system.

It will be appreciated that R-410A is an azeotrope-like composition. Thus, in order for the claimed compositions to be a good match for the operating characteristics of R-410A, the any of the refrigerants included in the heat transfer compositions of the invention, including each of Heat Transfer Compositions 1-20, desirably show a low level of glide. Thus, the refrigerants included in the heat transfer compositions of the invention, including each of Heat Transfer Compositions 1-20, according to invention as described herein may provide an evaporator glide of less than 2° C., preferably less than 1.5° C.

The heat transfer composition of the invention therefore preferably exhibits operating characteristics compared with R-410A wherein the efficiency (COP) of the composition is from 100 to 102% of the efficiency of R-410A in the heat transfer system and wherein the capacity is from 92 to 102% of the capacity of R-410A in the heat transfer system.

Preferably, the heat transfer composition of the invention preferably exhibits operating characteristics compared with R-410A wherein:
the efficiency (COP) of the composition is from 100 to 105% of the efficiency of R-410A; and/or
the capacity is from 92 to 102% of the capacity of R-410A, in heat transfer systems, in which the compositions of the invention are to replace the R-410A refrigerant.

In order to enhance the reliability of the heat transfer system, it is preferred that the heat transfer composition of the invention further exhibit the following characteristics compared with R-410A:
the discharge temperature is not greater than 10° C. higher than that of R-410A; and/or
the compressor pressure ratio is from 98 to 102% of the compressor pressure ratio of R-410A,
   in heat transfer systems, in which the composition of the invention is used to replace the R-410A refrigerant.

The existing heat transfer compositions used to replace R-410A are preferably used in air conditioning heat transfer systems including both mobile and stationary air conditioning systems. As used here, the term mobile air conditioning systems means mobile, non-passenger car air conditioning systems, such as air conditioning systems in trucks, buses and trains. Thus, each of the heat transfer compositions as described herein, including each of Heat Transfer Compositions 1-20, can be used to replace R-410A in any one of:
an air conditioning system including a mobile air conditioning system, particularly air conditioning systems in trucks, buses and trains,
a mobile heat pump, particularly an electric vehicle heat pump;
a chiller, particularly a positive displacement chiller, more particularly an air cooled or water-cooled direct expansion chiller, which is either modular or conventionally singularly packaged,
a residential air conditioning system, particularly a ducted split or a ductless split air conditioning system,
a residential heat pump,
a residential air to water heat pump/hydronic system,
an industrial air conditioning system and
a commercial air conditioning system particularly a packaged rooftop unit and a variable refrigerant flow (VRF) system;
a commercial air source, water source or ground source heat pump system.

The heat transfer composition of the invention is alternatively provided to replace R410A in refrigeration systems. Thus, each of the heat transfer compositions as described herein, including each of Heat Transfer Compositions 1-20, can be used to replace R10A in in any one of:
a low temperature refrigeration system,
a medium temperature refrigeration system,
a commercial refrigerator,
a commercial freezer,
an ice machine,
a vending machine,
a transport refrigeration system,
a domestic freezer,
a domestic refrigerator,
an industrial freezer,
an industrial refrigerator and
a chiller.

Each of the heat transfer compositions described herein, including each of Heat Transfer Compositions 1-20, is particularly provided to replace R-410A in a residential air-conditioning system (with an evaporator temperature in the range of about 0 to about 10° C., particularly about 7° C. for cooling and/or in the range of about −20 to about 3° C. or 30 to about 5° C., particularly about 0.5° C. for heating). Alternatively, or additionally, each of the heat transfer compositions described herein, including each of Heat Transfer Compositions 1-20, is particularly provided to replace R-410A in a residential air conditioning system with a reciprocating, rotary (rolling-piston or rotary vane) or scroll compressor.

Each of the heat transfer compositions described herein, including each of Heat Transfer Compositions 1-20, is particularly provided to replace R-410A in an air cooled chiller (with an evaporator temperature in the range of about 0 to about 10° C., particularly about 4.5° C.), particularly an air cooled chiller with a positive displacement compressor, more particular an air cooled chiller with a reciprocating scroll compressor.

Each of the heat transfer compositions described herein, including each of Heat Transfer Compositions 1-20, is particularly provided to replace R-410A in a residential air to water heat pump hydronic system (with an evaporator temperature in the range of about −20 to about 3° C. or about −30 to about 5° C., particularly about 0.5° C.).

Each of the heat transfer compositions described herein, including each of Heat Transfer Compositions 1-20, is particularly provided to replace R-410A in a medium temperature refrigeration system (with an evaporator temperature in the range of about −12 to about 0° C., particularly about −8° C.).

Each of the heat transfer compositions described herein, including each of Heat Transfer Compositions 1-20, is particularly provided to replace R-410A in a low temperature refrigeration system (with an evaporator temperature in the range of about −40 to about −12° C., particularly from about −40° C. to about −23° C. or preferably about −32° C.).

There is therefore provided a method of retrofitting an existing heat transfer system designed to contain or containing R-410A refrigerant or which is suitable for use with R-410A refrigerant, said method comprising replacing at least a portion of the existing R-410A refrigerant with a heat transfer composition of the present invention, including each of Heat Transfer Compositions 1-20.

There is therefore provided a method of retrofitting an existing heat transfer system designed to contain or containing R-410A refrigerant or which is suitable for use with R-410A refrigerant, said method comprising replacing at least a portion of the existing R-410A refrigerant with a heat transfer composition according to the present invention, including each of Heat Transfer Compositions 1-20.

The invention further provides a heat transfer system comprising a compressor, a condenser and an evaporator in fluid communication, and a heat transfer composition in said system, said heat transfer composition according to the present invention, including each of Heat Transfer Compositions 1-20.

Particularly, the heat transfer system is a residential air-conditioning system (with an evaporator temperature in the range of about 0 to about 10° C., particularly about 7° C. for cooling and/or in the range of about −20 to about 3° C. or about −30 to about 5° C., particularly about 0.5° C. for heating).

Particularly, the heat transfer system is an air-cooled chiller (with an evaporator temperature in the range of about 0° C. to about 10° C., particularly about 4.5° C.), particularly an air-cooled chiller with a positive displacement compressor, more particular an air-cooled chiller with a reciprocating or scroll compressor.

Particularly, the heat transfer system is a residential air to water heat pump hydronic system (with an evaporator temperature in the range of about −20° C. to about 3° C. or about −30° C. to about 5° C., particularly about 0.5° C.).

The heat transfer system can be a refrigeration system, such as a low temperature refrigeration system, a medium temperature refrigeration system, a commercial refrigerator, a commercial freezer, an ice machine, a vending machine, a transport refrigeration system, a domestic freezer, a domestic refrigerator, an industrial freezer, an industrial refrigerator and a chiller.

### EXAMPLES

### Comparative Example 1—Heat Transfer Compositions Comprising Refrigerant and POE Lubricant and BHT

A heat transfer composition of the present invention was tested in accordance with ASHRAE Standard 97—“Sealed Glass Tube Method to Test the Chemical Stability of Materials for Use within Refrigerant Systems” to simulate long-term stability of the heat transfer compositions by accelerated aging. The tested refrigerant consists of 41% by weight R-32, 3.5% by weight of R-125 and 55.5% by weight of CF3I), with 1.7 volume % air in the refrigerant. The POE lubricant tested was an ISO 32 POE having a viscosity at 40° C. of about 32 cSt and having a moisture content of 300 ppm or less (Lubricant A). Included with the lubricant was the stabilizer BHT, but no stabilizer according to the present invention was included. After testing, the fluid was observed for clarity and total acid number (TAN) was determined. The TAN value was considered to reflect the stability of the lubricant in the fluid under conditions of use in the heat transfer composition. The fluid was also tested for the presence of trifluormethane (R-23), which was considered to reflect refrigerant stability since this compound was believed to be a product of the breakdown of CF3I.

The experiment was carried out by preparing sealed tubes containing 50% by weight of the above-noted refrigerant blend and 50% by weight of the indicated lubricant, each of which has been degassed. Each tube contains a coupon of steel, copper, aluminum and bronze. The stability was tested by placing the sealed tube in an oven maintained at about 175° C. for 14 days. The results were as follows:

Lubricant Visual—yellow to brown

TAN->2 mgKOH/g

R-23->1 wt. %

### Examples 1A-1F—Stabilizers for Heat Transfer Compositions Comprising Refrigerant and POE Lubricant

The refrigerant composition identified in Table 2 below, known as R-466A (sold by Honeywell International under the trade designation Solstice® N-41) was tested for stability as described below.

TABLE 2
R-466A evaluated for Stability Examples

| | | | | GWP | |
|---|---|---|---|---|---|
| | HFC-32 | HFC-125 | CF₃ I | (100 | |
| Refrigerant | (wt. %) | (wt. %) | (wt. %) | years) | Flammability |
| R-466A | 49% | 11.5% | 39.5% | 733 | A1-Non Flammable |

A mixture comprising 50% by weight of the POE lubricant sold under the trade designation Emkrarate RL-32-3-MAF and 50% by weight of R-466A is produced. The relative amount as indicated in Table 3 of 1.6-dihydroxynaphtalene-(epichlorhydrin), also known as 1,6-diglycidyl naphthalene ether (DGE), and any co-stabilizer as indicated was included in the mixture. The resulting mixture was placed into a glass tube containing the metal coupons indicted in Table 3 below and then sealed. The sealed glass tube was put into an oven at 150° C. for 14 days. After such time the tube was removed and observed, and then the contents were tested. The following Table 3 reports on the materials tested and the results:

TABLE 3

| | Example No. | | | | | |
|---|---|---|---|---|---|---|
| | 1A | 1B | 1C | 1D | 1E | 1F |
| | wt. % | | | | | |
| Beaker Fluid | | | | | | |
| R-466A/POE | 99 | 98 | 96 | 96 | 95 | 95 |
| DGE | 1 | 2 | 4 | 4 | 4 | 4 |
| TCP | 0 | 0 | 0 | 0 | 1 | 1 |
| Total, wt. % | 100 | 100 | 100 | 100 | 100 | 100 |
| Metal | Cu/Al/Fe | Cu/Al/Fe | Cu/Al/Fe | Cu/Al/Fe/ | Cu/Al/Fe | Cu/Al/Fe/ |
| Coupons | | | | Brass | | Brass |
| Results | | | | | | |
| Visual | Clear | Clear | Clear | Clear | Clear | Clear |
| Observation | | | | | | |
| of Liquid | | | | | | |
| Fluoride, ppm | 1.3 | 1.2 | 1.2 | 1.3 | 1.6 | 2.1 |
| Iodide, ppm | <1.5 | <1.5 | <1.5 | <1.5 | <1.5 | <1.5 |
| Al, ppm | <3 | <3 | <3 | <3 | <3 | <3 |
| Fe, ppm | <2 | <2 | <2 | <2 | 2.7 | 2.5 |
| Cu, ppm | 18 | 7.3 | 5.2 | 4.8 | 3.9 | 10.8 |
| Zn, ppm | <1 | <1 | <1 | 1.4 | <1 | <1 |
| TAN | 0.3 | 0.2 | <0.1 | 0.25 | 0.1 | <0.1 |
| R-23, ppm | 40 | 30 | 20 | 20 | 15 | 30 |
| DGE (%) | 1.1 | 1.55 | 3.39 | 3.73 | 2.03 | NA* |

*NA indicates that the result is not available

In each of the tests, the results were unexpectedly and dramatically superior to the results using a stabilizer as in Comparative Example 1. Moreover, the uses of amounts of a stabilizer according to the present invention in amounts of 2%-4% produces an unexpectedly superior performance, in terms of Cu concentration, TAN and R-23 concentration.

Upon observation, the mixture is one phase, indicating that the refrigerant has during the period remained miscible and soluble in the POE oil. In addition, the liquid in the tube is in all cases clear, the coupons appear to remain unchanged.

It is also noted that the during the period the concentration of DGE in the mixture decreases. Although applicants do not intend to be bound by any particular theory, it is believed that this decrease represents the effectiveness of the present stabilizer, potentially as a radical scavenger, according to the following chemical reactions:

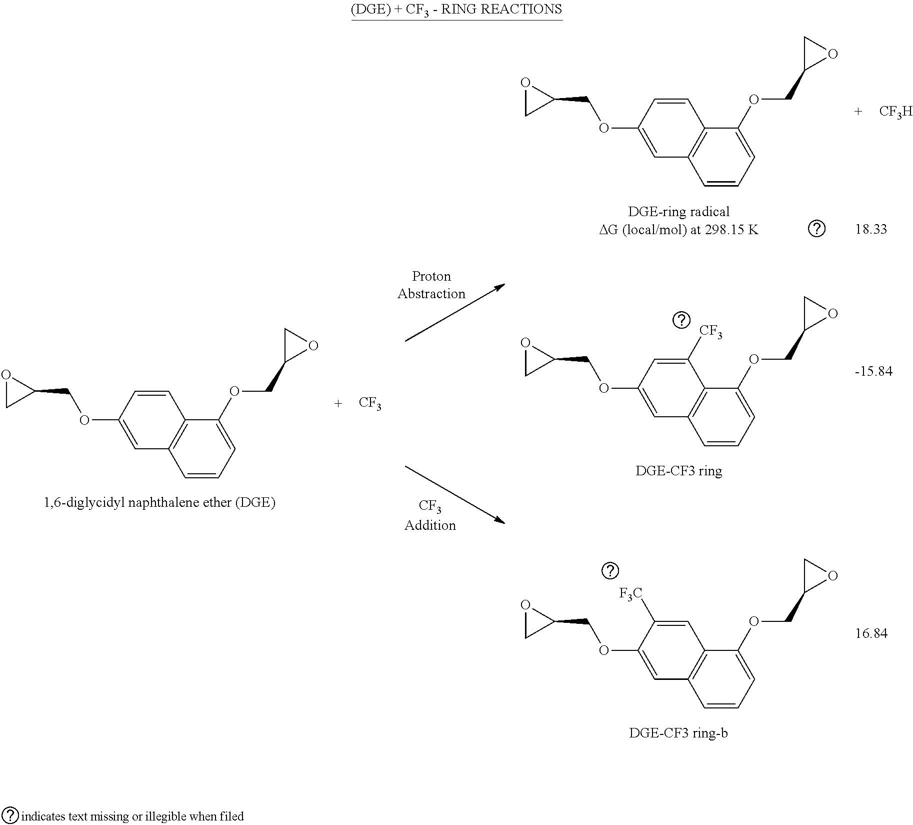

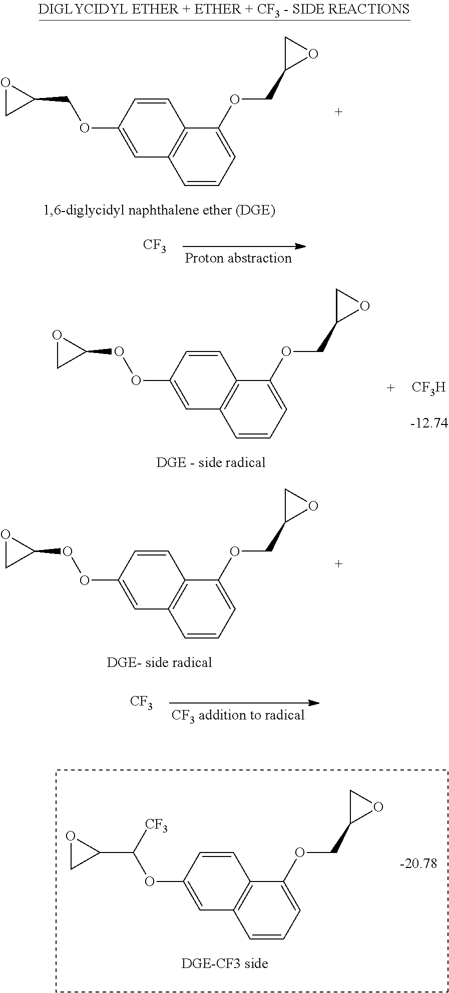

### Examples 2A-2G—Stabilizers for Heat Transfer Compositions Comprising Refrigerant and POE Lubricant in the Presence of Zinc

The refrigerant composition identified in Table 2 above is tested for stability as described below.

A mixture comprising 50% by weight of the POE lubricant sold under the trade designation Emkrarate RL-32-3-MAF and 50% by weight of R-466A was produced. The relative amount as indicated in Table 4 of 1.6-dihydroxynaphtalene-(epichlorhydrin), also known as 1,6-diglycidyl naphthalene ether (DGE), and any co-stabilizer as indicated in Table 4 is included in the mixture. The resulting mixture was placed into a glass tube containing the metal coupons indicted in Table 4 below and then sealed. The sealed glass tube was put into an oven at 150° C. for 14 days. After such time the tube was removed and observed, and then the contents were tested. The following Table 4 reports on the materials tested and the results:

TABLE 4

| | Example No. | | | | | |
|---|---|---|---|---|---|---|
| | 2A | 2B | 2C | 2D | 2E | 2F |
| | Wt. % | | | | | |
| Beaker Fluid | | | | | | |
| R-466A/POE | 99 | 98 | 98 | 97 | 97 | 96 |
| DGE | 1 | 1 | 2 | 2 | 3 | 3 |
| TCP | 0 | 1 | 0 | 1 | 0 | 1 |
| Total, wt. % | 100 | 100 | 100 | 100 | 100 | 100 |
| Metal | Cu/Al/Fe/Zn | Cu/Al/Fe/Zn | Cu/Al/FeZn | Cu/Al/Fe/Zn | Cu/Al/Fe/Zn | Cu/Al/Fe |
| Coupons | | | | | | |
| Results | | | | | | |
| Visual | Yellow | Slightly | Clear | Clear | Clear | Clear |
| Observation | tint | hazy | | | | |
| of Liquid | | | | | | |
| Fluoride, ppm | 7.8 | 4.5 | 3.6 | 2.7 | 3.3 | NA* |
| Iodide, ppm | 517 | 3.8 | <1.5 | <1.5 | <1.5 | NA |
| Al, ppm | <3 | <3 | 7.2 | NA | NA | NA |
| Fe, ppm | <2 | <2 | 5 | NA | NA | NA |
| Cu, ppm | 0.87 | <0.4 | <0.4 | NA | NA | NA |
| Zn, ppm | 169 | 24.6 | 41.7 | NA | NA | NA |
| TAN | 1.2 | 0.15 | <.45 | <0.1 | 0.3 | NA |
| R-23, ppm | 750 | 175 | 165 | 50 | 90 | 45 |

*NA indicates that the result is not available

In each of the tests, the results were unexpectedly superior to the results using a stabilizer as in Comparative Example 1. Moreover, the use of a stabilizer comprising at least 2% of a stabilizer according to the present invention and at least 1% of TCP produces an unexpectedly superior performance, in terms of Fl concentration, TAN and R-23 concentration when zinc is present.

Upon observation, the mixture was one phase, indicating that the refrigerant has during the period remained miscible and soluble in the POE oil. In addition, the liquid in the tube is in all cases clear, except Examples 2A and 2B, and the coupons appear to remain unchanged.

### Examples 3A-3H—Stabilizers for Heat Transfer Compositions Comprising Refrigerant and PVE Lubricant

The refrigerant composition identified in Table 2 above is tested for stability as described below.

A mixture comprising 50% by weight of the PVE lubricant sold under the trade designation FVC68D and 50% by weight of R-466A is produced. The relative amount as indicated in Table 5 of 1.6-dihydroxynaphtalene-(epichlorhydrin), also known as 1,6-diglycidyl naphthalene ether (DGE), and any co-stabilizer as indicated was included in the mixture. The resulting mixture was placed into a glass tube containing the metal coupons indicted in Table 5 below and then sealed. The sealed glass tube was put into an oven at 150° C. for 14 days. After such time the tube was removed and observed, and then the contents were tested. The following Table 5 reports on the materials tested and the results:

TABLE 5

| | Example No. | | | | | | | | | |
|---|---|---|---|---|---|---|---|---|---|---|
| | 3A | 3B | 3C | 3D | 3E | 3F | 3G | 3H | 3I | 3J |
| | Wt. % | | | | | | | | | |
| Beaker Fluid | | | | | | | | | | |
| R-466A/PVE | 99 | 98 | 97 | 96 | 99 | 98 | 97 | 96 | 95 | 95 |
| DGE | 1 | 2 | 3 | 4 | 1 | 2 | 3 | 4 | 4 | 4 |
| TCP | 0 | 0 | 0 | 0 | 0 | 0 | 0 | 0 | 1 | 1 |
| Total, wt. % | 100 | 100 | 100 | 100 | 100 | 100 | 100 | 100 | 100 | 100 |
| Metal | Cu/Al/Fe | Cu/Al/Fe | Cu/Al/Fe | Cu/Al/Fe/ | Cu/Al/Fe/ | Cu/Al/Fe/ | Cu/Al/Fe/ | Cu/Al/Fe/ | Cu/Al/Fe | CU/Al/Fe/ |
| Coupons | | | | | Brass | Brass | Brass | Brass | | Brass |
| Results | | | | | | | | | | |
| Visual | Clear | Clear | Clear | Clear | Clear | Clear | Clear | Clear | Clear | Clear |
| Observation | | | | | | | | | | |
| of Liquid | | | | | | | | | | |
| Fluoride, ppm | 3.9 | 2.3 | 3.3 | 1.5 | 4.6 | 1.8 | 3.2 | 1.3 | 2.5 | 1.6 |
| Iodide, ppm | <1.5 | <1.5 | <1.5 | <1.5 | <1.5 | <1.5 | <1.5 | <1.5 | <1.5 | <1.5 |
| Al, ppm | <3 | <3 | <3 | <3 | <3 | <3 | <3 | <3 | <3 | <3 |
| Fe, ppm | <2 | 3.2 | <2 | <2 | <2 | <2 | <2 | 3 | <2 | <2 |
| Cu, ppm | 9 | 3.2 | 5.6 | 1.8 | 10.8 | 1.9 | 2.6 | 3.1 | 1.4 | 1.6 |
| Zn, ppm | 10.9 | 10.8 | 11.7 | <1 | 17.1 | 10.9 | 10 | <1 | <1 | 1.2 |
| TAN | 0.1 | 0 < 0.1 | <0.1 | 0.1 | 0.25 | 0.15 | 0.1 | 0.1 | 0.1 | <0.1 |
| R-23, ppm | 260 | 140 | 115 | 70 | 340 | 160 | 105 | 70 | 75 | 75 |

In each of the tests, the results were unexpectedly and dramatically superior to the results using a stabilizer as in Comparative Example 1. Moreover, the use of amounts of a stabilizer according to the present invention in amounts of at least 4% produces an unexpectedly superior performance, in terms of Zn concentration when Zn is present (as is the case with the brass coupons), being in a preferred range of less than 10 ppm, and in terms of R-23 concentration, being less than the preferred range of less than 100 ppm, for all of the metals tested, including when brass is present.

Upon observation, the mixture is one phase, indicating that the refrigerant has during the period remained miscible and soluble in the PVE oil. In addition, the liquid in the tube was in all cases clear, and the coupons appear to remain unchanged.

### Examples 4A-4E—Stabilizers for Heat Transfer Compositions Comprising Refrigerant and PVE Lubricant in the Presence of Zinc

The refrigerant composition identified in Table 2 above is tested for stability as described below.

A mixture comprising 50% by weight of the PVE lubricant sold under the trade designation FVE68D and 50% by weight of R-466A is produced. The relative amount as indicated in Table 6 of 1.6-dihydroxynaphtalene-(epichlorhydrin), also known as 1,6-diglycidyl naphthalene ether (DGE), and any co-stabilizer as indicated is included in the mixture. The resulting mixture was placed into a glass tube containing each of a Cu, Al, Fe and Zn metal coupon and then sealed. The sealed glass tube was put into an oven at 150° C. for 14 days. After such time the tube was removed and observed, and then the contents were tested. The following Table 6 reports on the materials tested and the results:

TABLE 6
Zinc Present

| | Example No. | | | | |
|---|---|---|---|---|---|
| | 4A | 4B | 4C | 4D | 4E |
| | Wt. % | | | | |
| Beaker | | | | | |
| Fluid | | | | | |
| R-466A/PVE | 99 | 98 | 97 | 96 | 95 |
| DGE | 1 | 2 | 3 | 4 | 4 |
| TCP | 0 | 0 | 0 | 0 | 1 |
| Total, wt. % | 100 | 100 | 100 | 100 | 100 |
| Results | | | | | |
| Visual | Dark | Slightly | Slightly | Clear | Clear |
| Observation | Brown | hazy | hazy | | |
| of Liquid | | | | | |
| Fluoride, | NA* | 2.9 | 3.7 | 1.6 | 2.2 |
| ppm | | | | | |
| Iodide, ppm | NA | <1.5 | <1.5 | <1.5 | <1.5 |
| Al, ppm | NA | <3 | <3 | <3 | <3 |
| Fe, ppm | NA | <2 | <2 | <2 | <2 |
| Cu, ppm | NA | <0.4 | 1.3 | 5.1 | <0.4 |
| Zn, ppm | NA | 75.7 | 25.5 | 2.2 | <1 |
| TAN | NA | 0.2 | 0.2 | 0.15 | 0.15 |
| R-23, ppm | NA | 515 | 205 | 100 | 115 |

*NA indicates that the result is not available

In each of the tests, except test 4A containing only 1% of DGE stabilizer, the results were unexpectedly and dramatically superior to the results using a stabilizer as in Comparative Example 1. Moreover, the uses of amounts of a stabilizer according to the present invention in amounts of at least 4% produces an unexpectedly superior performance, in terms of liquid clarity, Zn concentration, being in a preferred range of less than 10 ppm, and in terms of R-23 concentration, being in the preferred range of about 100 ppm or less, for all of the metals tested, including in the presence of zinc.

Upon observation, the mixture was one phase, indicating that the refrigerant has during the period remained miscible and soluble in the PVE oil. In addition, the liquid in the tube is in all cases clear, the coupons appear to remain unchanged.

### Example 5A-5B—Stabilizers for Heat Transfer Compositions Comprising Refrigerant and PVE Lubricant in the Presence of Zinc with EHGE Co-Stabilizer

The refrigerant composition identified in Table 2 above is tested for stability as described below.

A mixture comprising 50% by weight of the PVE lubricant sold under the trade designation FVC68D by Idemitsu and 50% by weight of R-466A is produced. The relative amount as indicated in Table 7 of 1.6-dihydroxynaphtalene-(epichlorhydrin), also known as 1,6-diglycidyl naphthalene ether (DGE), and EHGE as co-stabilizer as indicated was included in the mixture. The resulting mixture was placed into a glass tube containing each of a Cu, Al, Fe and Zn metal coupon and then sealed. The sealed glass tube was put into an oven at 150° C. for 14 days. After such time the tube was removed and observed, and then the contents were tested. The following Table 7 reports on the materials tested and the results:

TABLE 7
Zinc Present

| | Example No. | | |
|---|---|---|---|
| | 5A | 5B | 5C |
| | Wt. % | | |
| Beaker | | | |
| Fluid | | | |
| R-466A/PVE | 96 | 95 | 94 |
| DGE | 4 | 4 | 4 |
| EHGE | 0 | 1 | 2 |
| Total, wt. % | 100 | 100 | 100 |
| Results | | | |
| Visual | Clear | Clear | Clear |
| Observation | | | |
| of Liquid | | | |
| Fluoride, | 1.6 | 2.5 | 2.7 |
| ppm | | | |
| Iodide, ppm | <1.5 | <1.5 | <1.5 |
| Al, ppm | <3 | <3 | 7.9 |
| Fe, ppm | <2 | <2 | <2 |
| Cu, ppm | 5.1 | 10.7 | 1.8 |
| Zn, ppm | 2.2 | 12.6 | <1 |
| TAN | 0.15 | 0.25 | 0.1 |
| R-23, ppm | 100 | 100 | 70 |
| DGE (%) | 2.37 | NA* | NA |

*NA indicates that the result is not available

In each of the tests, the results were unexpectedly and dramatically superior to the results using a stabilizer as in Comparative Example 1. Moreover, the use of amounts of a stabilizer according to the present invention in amounts of least 4 weight %, including with EHGE as co-stabilizer, provides unexpectedly superior performance, in terms of liquid clarity, Zn concentration, being in a preferred range of less than 10 ppm, and in terms of R-23 concentration, being in the preferred range of about 100 ppm or less, for all of the metals tested in the presence of zinc.

Upon observation, the mixture was one phase, indicating that the refrigerant has during the period remained miscible and soluble in the PVE oil. In addition, the liquid in the tube was in all cases clear, and the coupons appear to remain unchanged.

### Example 6A—Long Term Compressor Stability with Stabilized FVC68D Lubricant

A rotary compressor was operated for 6000 hours with refrigerant R466A and PVE lubricant sold under the trade designation FVC68D, except that the lubricant was stabilized according to the present invention by adding DGE in an amount of 3% by weight and TCP in an amount of 1% by weight, each based on the weight of the lubricant plus said stabilizers. The compressor did not include any zinc components which would be exposed under operation to the lubricant at temperatures above about 100° F. and was operated under the following conditions:

Discharge Temperature: 200° F.
Discharge Pressure: 280 psia
Suction Temperature: 120° F.
Suction Pressure: 100 psia
Lubricant loading: about 40% by weight based on total refrigerant plus
lubricant in the system

The refrigerant was sampled and analyzed at various times during the operation of the compressor to determine the generation of R23, a breakdown product of CF3I decomposition. The results reported in Table 8A below were obtained:

TABLE 8A

| | R23 weight concentration | R23 Generation |
|---|---|---|
| Hours | (ppm) | (ppm/day) |
| 64 | 30 | 1.5 |
| 544 | 60 | 2.0 |
| 929 | 180 | 2.9 |
| 1478 | 270 | 3.1 |
| 1988 | 330 | 3.4 |
| 2506 | 440 | 4.2 |
| 2578 | 450 | 4.2 |
| 2940 | 550 | 4 |
| 3443 | 650 | 4.4 |
| 4094 | 685 | 4.0 |
| 4491 | 780 | 4.2 |
| 5012 | 960 | 4.5 |
| 5592 | 980 | 4.2 |
| 6096 | 1005 | 4.0 |

The results show a commercially acceptable rate of R23 generation in the accelerated test of this example, it being noted that the test is accelerated in the sense that operation of the compressor was continuous (as opposed to normal operation in which the compressor is periodically cycled off during normal operation) and at a temperature that is about 50° F. above about a typical discharge temperature. These results demonstrate the long-term reliability of vapor compression systems using CF3I-containing refrigerant and PVE lubricant stabilized in accordance with the present invention. The results of this test as reported in Table 8 above show that the R23 concentration stabilized at about 4 ppm/day, which indicates long term reliability of CF3I-containing refrigerant with the stabilized PVE lubricant of the present invention.

In addition, the stabilized PVE lubricant was sampled at various times during the test and analyzed to determine TAN, the concentration of fluoride and iodide anions and various metals that can result from the degradation of CF3I. The results reported in Table 8B below were obtained:

TABLE 8B

| | | Anions (ppm) | | Metals (ppm) | | | |
|---|---|---|---|---|---|---|---|
| Hours | TAN | Fluoride | Iodide | Cu | Al | Fe | Zn |
| 0 | <0.2 | <1 | <4 | <1 | <1 | <1 | <1 |
| 544 | <0.2 | <1 | <4 | <1 | <1 | <1 | <1 |
| 929 | <0.2 | <1 | <4 | <1 | <1 | <1 | <1 |
| 1478 | <0.2 | <1 | <4 | <1 | <1 | <1 | <1 |
| 1988 | <0.2 | <1 | <4 | <1 | <1 | <1 | <1 |
| 2578 | <0.2 | <1 | <4 | <1 | <1 | <1 | <1 |
| 2940 | <0.2 | <1 | <4 | <1 | <1 | <1 | <1 |
| 4094 | <0.2 | <1 | <4 | <1 | <1 | <1 | <1 |
| 4491 | <0.2 | <1 | <4 | <1 | <1 | <1 | <1 |
| 5012 | <0.2 | <1 | <4 | <1 | <1 | <1 | <1 |
| 5592 | <0.2 | <1 | <4 | <1 | <1 | <1 | <1 |
| 6096 | <0.2 | <1 | <4 | <1 | <1 | <1 | <1 |

As can be seen from the results in Table 8B above, fluoride, iodide, and metals concentrations were well below any concentration that would indicate a reliability issue with the use of the stabilized PVE lubricant of the present invention with CF3I-containing refrigerant. That is, throughout the accelerated test, fluoride and iodide anions were well below 10 ppm and each of the metals was below 50 ppm.

### Example 6B—Long Term Compressor Stability with Stabilized FVC32D Lubricant

Example 6A is repeated, except that the lubricant is FVC32D. Similar favorable results are achieved.

### Example 6D—Long Term Compressor Stability with Stabilized Lubricant 6A

Example 6A is repeated, except that the lubricant is Lubricant 6A. Similar favorable results are achieved.

### Example 6E—Long Term Compressor Stability with Stabilized Lubricant 6B

Example 6A is repeated, except that the lubricant is Lubricant 6B. Similar favorable results are achieved.

### Example 6D—Long Term Compressor Stability with Stabilized Lubricant 6C

Example 6A is repeated, except that the lubricant is Lubricant 6C. Similar favorable results are achieved.

### Example 7A—Long Term Compressor Stability with Stabilized RL68H Lubricant

A rotary compressor is operated for 6000 hours with refrigerant R466A, and POE lubricant sold under the trade designation RL68H, except that the lubricant was stabilized according to the present invention by adding DGE in an amount of 3% by weight and TCP in an amount of 1% by weight, each based on the weight of the lubricant plus said stabilizers. The compressor does not include any zinc components which would be exposed under operation to the lubricant above about 100° F. and was operated under the following conditions:

Discharge Temperature: 200° F.
Discharge Pressure: 280 psia
Suction Temperature: 120° F.
Suction Pressure: 100 psia

The refrigerant was sampled and analyzed at various times during the operation of the compressor to determine the generation of R23, a breakdown product of CF3I decomposition, and the results show a commercially acceptable rate of R23 generation in an accelerated test, which demonstrates the long-term reliability of vapor compression systems using CF3I-containing refrigerant and POE lubricant stabilized in accordance with the present invention. In addition, the stabilized POE lubricant is sampled at various times during the test and analyzed to determine TAN, the concentration of fluoride and iodide anions and various metals indicated in Table 8B above. Fluoride, iodide, and metals concentrations are well below any concentration that would indicate a reliability issue with the use of the stabilized POE lubricant of the present invention with CF3I-containing refrigerant. That is, throughout the accelerated test, fluoride and iodide anions are well below 10 ppm and each of the metals are below 50 ppm.

### Example 7B—Long Term Compressor Stability with Stabilized RL32-3MAF Lubricant

Example 7A is repeated, except that the lubricant is RL32-3MAF. Similar favorable results are achieved.

### Example 7C—Long Term Compressor Stability with Stabilized Lubricant 4

Example 7A is repeated, except that the lubricant is Lubricant 4A. Similar favorable results are achieved.

### Example 7D—Long Term Compressor Stability with Stabilized Lubricant 5

Example 7A is repeated, except that the lubricant is Lubricant 5. Similar favorable results are achieved.

1. A heat transfer composition comprising at least one iodocarbon compound and at least one stabilizing compound according to the following Formula I: 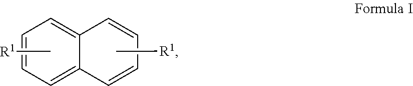
where each R¹ is independently an epoxy terminated ethoxy, propoxy or butoxy group.

2. The heat transfer composition of claim 1 where each R¹ is independently an epoxy terminated ethoxy or propoxy group.

3. The heat transfer composition of claim 1 where each R¹ is independently an epoxy terminated ethoxy, propoxy or butoxy group, provided that at least one R¹ is an epoxy terminated ethoxy group.

4. The heat transfer composition of claim 1 where each R¹ is independently an epoxy terminated ethoxy or propoxy group, provided that at least one R¹ is an epoxy terminated ethoxy group.

5. The heat transfer composition of claim 1 where each R¹ is an epoxy terminated ethoxy group.

6. The heat transfer composition of claim 1 wherein said stabilizing compound according to Formula I comprises:

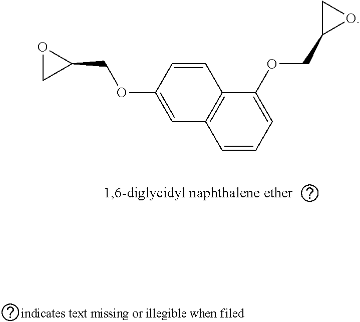 [SMILES: c1cc(OC[C@H]2CO2)c2ccc(OC[C@H]3CO3)cc2c1]

7. The heat transfer composition of claim 6 further comprising a PVE lubricant.

8. The heat transfer composition of claim 1 wherein said stabilizing compound is present in the composition in an amount of from about 1% to about 5% by weight based on the weight of said lubricant and said stabilizing compound.

9. The heat transfer composition of claim 6 wherein said stabilizing compound is present in the composition in an amount of from about 1% to about 5% by weight based on the weight of said lubricant and said stabilizing compound.

10. A stabilized lubricant comprising a PVE lubricant and at least one stabilizing compound according to the following Formula I: 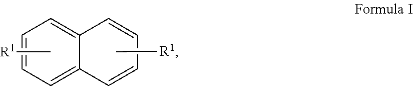
where each R¹ is independently an epoxy terminated ethoxy, propoxy or butoxy group.

11. The stabilized lubricant of claim 10 where each R¹ is independently an epoxy terminated ethoxy or propoxy group, provided that at least one R¹ is an epoxy terminated ethoxy group.

12. The stabilized lubricant of claim 10 where each R¹ is an epoxy terminated ethoxy group.

13. The stabilized lubricant of claim 10 wherein said stabilizing compound according to Formula I comprises:

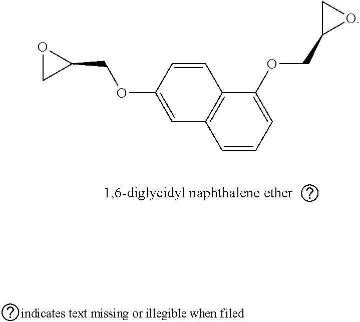 [SMILES: c1cc(OC[C@H]2CO2)c2ccc(OC[C@H]3CO3)cc2c1]

14. The stabilized lubricant of claim 10 where said stabilizing compound is present in the composition in an amount of from about 1% to about 5% by weight based on the weight of said lubricant and said stabilizing compound.

15. The stabilized lubricant of claim 13 wherein said stabilizing compound is present in the composition in an amount of from about 1% to about 5% by weight based on the weight of said lubricant and said stabilizing compound.

16. A heat transfer system comprising a compressor, a heat transfer composition comprising a CF3I-containing refrigerant, a PVE lubricant and at least one stabilizing compound according to the following Formula I: 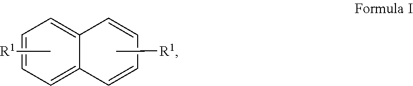
where each R¹ is independently an epoxy terminated ethoxy, propoxy or butoxy group.

17. The heat transfer system of claim 16 where each R¹ is an epoxy terminated ethoxy group.

18. The heat transfer system of claim 16 wherein said stabilizing compound according to Formula I comprises:

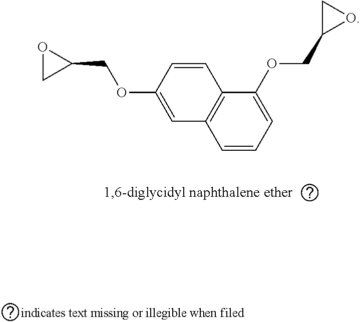 [SMILES: c1cc(OC[C@H]2CO2)c2ccc(OC[C@H]3CO3)cc2c1]

19. The heat transfer system of claim 17 where said stabilizing compound is present in the composition in an amount of from about 1% to about 5% by weight based on the weight of said lubricant and said stabilizing compound.

20. The heat transfer system of claim 19 wherein said compressor is essentially free of zinc-containing components exposed to said lubricant.
